(19) United States
(12) Patent Application Publication
(10) Pub. No.: US 2017/0169173 A1
(43) Pub. Date: Jun. 15, 2017

(54) SYSTEM FOR ADAPTING HEALTHCARE DATA AND PERFORMANCE MANAGEMENT ANALYTICS

(71) Applicant: Cedar Gate Partners, LLC, Greenwich, CT (US)

(72) Inventors: David B. Snow, JR., Darien, CT (US); Christian Nickerson, Darien, CT (US); Kenneth Brown, Yorktown Heights, NY (US); Joshua Davis, McKinney, TX (US); Aarti Karamchandani, Oak Brook, IL (US); Key Shin, New City, NY (US); Stephen Zander, Chicago, IL (US); Michael Pardes, Montvale, NJ (US)

(21) Appl. No.: 15/374,258

(22) Filed: Dec. 9, 2016

Related U.S. Application Data
(60) Provisional application No. 62/265,209, filed on Dec. 9, 2015.

(51) Int. Cl. G06F 19/00

(52) U.S. Cl. CPC G06F 19/324; G06F 19/328; G06F 19/327

(57) ABSTRACT

Methods and systems for monitoring and managing healthcare performance. The system comprises one or more network interfaces configured to provide access to a network and one or more data processing servers coupled to the one or more network interfaces to enable communication with one or more healthcare manager devices. The one or more data processing servers to execute instructions to receive healthcare data from a plurality of data source devices over the network, extract patient medical data from the received healthcare data, group the patient medical data according to episodes of care, analyze the patient medical data to determine variances, generate prescriptive opportunity scripts to reduce the determined variances, add the prescriptive opportunity scripts to a playbook, and generate output corresponding to the analysis and the playbook to the one or more healthcare manager devices.

### CROSS REFERENCE TO RELATED APPLICATION

This application claims the priority of U.S. Provisional Application No. 62/265,209, entitled “SYSTEM AND METHOD FOR GENERATING SCRIPTS FROM DATA ANALYTICS,” filed on Dec. 9, 2015, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Field of the Invention

The invention described herein generally relates to collecting and analyzing data, and in particular, performing analytic operations on various types of healthcare data to identify opportunities for cost savings and other improvements in financial, operational and clinical performance.

Description of the Related Art

The cost of health care in the United States is on an unsustainable trajectory. Healthcare systems are struggling with rising costs and uneven quality despite the hard work of well-trained, well-intended clinicians and organizations. The healthcare industry is transforming itself by injecting value-based competition to encourage the system to drive providers to compete on value and outcome of care delivery. A large component of transformation is the transition of fee-for-service (FFS) reimbursement for clinical services to fee-for-value (FFV) designed to elevate and reward those that provide high-quality care and eliminate inefficiencies and wasteful spending. In a value-based healthcare system, decision making becomes more difficult than ever before, and poor decisions can punish business performance.

The healthcare spend in the U.S. in 2015, as reported by Center of Medicare Services, was 3.2 trillion dollars, or 17.8 percent of GDP. This is a higher percentage of GDP than any other country in the world. Healthcare spend is at the current growth rate of approximately 6% per year which is outpacing the economic growth rate in the U.S. by a factor of 2.

The U.S. healthcare system financial reimbursement structure for care delivery has been a zero-sum game among providers and payors with payors trying to control financial cost by imposing financial controls such as physician networks, prior authorizations for services, reduction in fee schedules in return for more patient volume and other limiting structures. restricting competition and creating perverse incentives for physicians to make decisions that are financial influenced over sound clinical decisions that drives up costs and hurts the quality of patient care.

The strategy of creating a value-based competition among the healthcare constituents will drive down cost, increase quality and consumer satisfaction as proven in many other industries. Competition cannot be based on single physician services or how healthplans negotiate that reimbursement but rather on the end-to-end care, or episode of care, that a patient receives either in an event based episode like a knee replacement or over the course of a period of time as associated with a chronic condition like diabetes.

The movement to value-based competition and value-based care has begun with Center of Medicare and Medicaid Services (CMS), which is the largest payor in the U.S. Healthcare System. In January 2015, CMS has committed to move 50% of traditional fee-for-service payments to value-based payments models, such as shared savings and bundled payments, by 2018. Shortly after, 20 major health systems and payors committed to transition 75% of their FFS reimbursement to value-based arrangements by 2020.

The majority of the healthcare delivery systems will have to transform themselves in order to manage the financial and clinical risk that will be imposed on them from entering into value-based arrangements. This will require deep expertise in managing data and actuarial analytics, typically found with payors, in order to assess the risk of the population they serve. In addition, the healthcare delivery system will need to manage change from an organizational, operational, clinical and behavioral change perspective.

The market has gravitated to leveraging spot analytics to identify patient gaps-in-care or one-to-one opportunities. One-to-one opportunities, e.g. identifying a diabetic not being adherent to their prescribed medications, are very costly and risk the return on investment for transient patients. Although these tactics are ultimately necessary to complete the value based equation, there are foundational system components that need to be put in place before delivery systems can realize the full value of one-to-one based analytics and interventions.

One-to-many analytics are analytics that deliver opportunities that fortify the foundation of a delivery system, where one decision affects thousands of patients and millions of dollars from a cost and quality perspective. These types of analytics encompass standardizing clinical protocols to reduce clinical protocol variation, reduce complications and inform physicians to make better referral decisions.

With the Affordable Care Act passage, healthcare organizations are being asked to do more than ever before—to cut fixed and variable costs, manage capacity and risk, and grow revenue while improving outcomes across patient populations—all at the same time. This means making decisions that maximize revenues, improve clinical outcomes, and optimize operational effectiveness and efficiency. Current healthcare systems do not adequately account for containing costs and maintaining the quality of service. Thus, there is a need for performing data analysis of medical care data to help identify opportunities to enable continuous value improvement in the emerging FFV world.

### SUMMARY OF THE INVENTION

The present invention provides methods and systems for monitoring and managing healthcare performance. According to one embodiment, the system comprises one or more network interfaces configured to provide access to a network and one or more data processing servers coupled to the one or more network interfaces to enable communication with one or more healthcare manager devices. The one or more data processing servers to execute instructions to receive healthcare data from a plurality of data source devices over the network, extract patient medical data from the received healthcare data, group the patient medical data according to episodes of care, analyze the patient medical data to determine variances, generate prescriptive opportunity scripts to reduce the determined variances, add the prescriptive opportunity scripts to a playbook, and generate output corresponding to the analysis and the playbook to the one or more healthcare manager devices.

The one or more data processing servers may be further configured to analyze clinically related activities during episodes of care and evaluate unnecessary costs. The one or more data processing servers can also be configured to analyze relationships between primary care physicians and attributed physicians. In another embodiment, the one or more data processing servers may be configured to analyze relationships between primary care physicians and attributed physicians for treating patients which require an inpatient admission. In yet another embodiment, the one or more data processing servers can be further configured to identify an overall scope of prescriptive opportunities, for a given physician, from a plurality of clinical pathways and a plurality of advisor logics, and summarize a playbook campaign engagement of the given physician.

The healthcare data can include health service transactions, patient medical data, physician data, health plan data, provider contract data, lab data, pharmacy data, market trend data, reference data, payment data, and reimbursement data. The generated output may be comprised of a graphical user interface that is accessible via a web-based feature, a software application, or a cloud computing service.

According to another embodiment, the system comprises a data aggregator that collects healthcare data from one or more data source systems, an analytic engines module configured to analyze the healthcare data to identify variances in patient care and execute at least one advisor logic, a performance monitoring component configured to generate performance data based on the healthcare data, and generate graphical user interface data based on the performance data, the analysis of the healthcare data, execution of the at least one advisor logic, and a playbook, the graphical user interface accessible via a network and enables user access to the performance data, the at least one advisor logic, and the playbook. The system further comprises an opportunity generator configured to create prescriptive opportunities for the at least one advisor logic based on the performance data and the analysis of the healthcare data, and a playbook module configured to generate scripts associated with the created opportunities, create the playbook, and add a selection of the scripts to the playbook.

The healthcare data may include health service transactions, patient medical data, physician data, health plan data, provider contract data, lab data, pharmacy data, market trend data, reference data, payment data, and reimbursement data. The graphical user interface may be accessible via a web-based feature, a software application, or a cloud computing service. The at least one advisor logic may be any one of a clinical advisor logic, a network referral advisor logic, an inpatient advisor logic, and a physician advisor logic.

The analytic engines module may be further configured to analyze clinically related activities during episodes of care and evaluate unnecessary costs. Alternatively, the analytic engines module may be further configured to analyze relationships between primary care physicians and attributed physicians. One embodiment includes the analytic engines module further configured to analyze relationships between primary care physicians and attributed physicians for treating patients which require an inpatient admission. According to another embodiment, the analytic engines module is further configured to: identify an overall scope of prescriptive opportunities, for a given physician, from a plurality of clinical pathways and a plurality of advisor logics, and summarize a playbook campaign engagement of the given physician.

The performance monitoring component can be further configured to monitor performance of the created opportunities associated with the selection of scripts added to the playbook. The performance data may include contract financial performance, clinical performance, and operational performance. In one embodiment, the analytics models engine is further configured to compare performance data, generate cost distributions, and determine an optimal intersection between cost and quality of care.

According to one embodiment, the method comprises retrieving, by the one or more data processing servers, healthcare data from a plurality of data source devices over a network, extracting, by the one or more data processing servers, patient medical data from the received healthcare data, grouping, by the one or more data processing servers, the patient medical data according to episodes of care, analyzing, by the one or more data processing servers, the patient medical data to determine variances, generating, by the one or more data processing servers, prescriptive opportunity scripts to reduce the determined variances, adding, by the one or more data processing servers, the prescriptive opportunity scripts to a playbook, connecting, by the one or more data processing servers, to one or more network interfaces to enable communication with one or more healthcare manager devices, and generating, by the one or more data processing servers, output corresponding to the analysis and the playbook to the one or more healthcare manager devices.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention is illustrated in the figures of the accompanying drawings which are meant to be exemplary and not limiting, in which like references are intended to refer to like or corresponding parts.

FIG. 1 illustrates a networked computing system according to an embodiment of the present invention.

FIG. 2 illustrates a dataflow diagram of a computing system according to an embodiment of the present invention.

FIG. 3 illustrates a component diagram of a computing system according to an embodiment of the present invention.

FIG. 4 illustrates a flowchart of a method for generating analytical data output according to an embodiment of the present invention.

FIG. 5 illustrates a flowchart of a method for performing exemplary statistical analysis of episode data according to an embodiment of the present invention.

FIGS. 6A and 6B illustrates an exemplary dashboard interface according to an embodiment of the present invention.

FIG. 7A-7F illustrates an exemplary clinical advisor interface according to an embodiment of the present invention.

FIG. 8A-8C illustrates an exemplary network referral advisor interface according to an embodiment of the present invention.

FIG. 9A-9C illustrates an exemplary inpatient advisor interface according to an embodiment of the present invention.

FIG. 10A-E illustrates an exemplary physician advisor interface according to an embodiment of the present invention.

FIG. 11A through FIG. 11C illustrate an exemplary playbook interface according to an embodiment of the present invention.

FIG. 12 illustrates an exemplary network leakage interface according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

Embodiments of the present invention provide for systems and methods for generating business intelligence from collections of healthcare data. In particular, the disclosed system comprises a platform that uses historical and recent medical claims data, financial contract data, and other healthcare and patient data, and applies prescriptive analytics, actuarial analyses and risk-adjusted mean comparisons to identify and quantify performance improvement opportunities. Healthcare data may include data from electronic medical records (EMR), claims, general ledger data, beneficiaries, drug and lab records, admission, discharge and transfer systems. Healthcare data can be collected from sources such as healthcare insurance administrations, payer-provider reimbursement contracting, physician healthcare services or providers, and physician billing and reimbursements. The healthcare data can be transformed from raw data into meaningful and useful information for health service managers and administrators who run medical practices and health care facilities. An actuarial system may be provided to predict costs for accountable care organizations (ACOs) to ensure patient quality of service for care, operational efficiency, and financial well-being. The system is capable of handling large amounts of unstructured data to help the health service managers and administrators, who oversee the functions of ACOs, to identify, develop and otherwise create strategic business decisions. Business decisions may include modifying treatment protocols, pricing, staff, medications, etc., to meet certain priorities and goals.

Analytics may be performed on the healthcare data to determine where money is wasted and where inefficiencies exist. Information collected from healthcare data may indicate at least the identity of patients, healthcare professionals performing care or treatment to the patients, type of care or treatment is performed on the patients for given conditions, where the care or treatment is given, and when the care or treatment was provided. Historical, current and predictive views of business operations may be generated by reporting, online analytical processing, analytics, data mining, process mining, complex event processing, business performance management, benchmarking, text mining, predictive analytics and prescriptive analytics.

In at least one embodiment, data derived from external data (external parties) may be combined with data from sources internal to an organization such as financial and operations data (internal data) to provide a wide overview of care provided by a plurality of healthcare service networks. Healthcare services include, but are not limited to, services provided by primary care physicians and specialists, acute care such as radiology, out-patient, and inpatient, and post-acute care such as skilled nursing, rehabilitation, and home health. Data clusters may be formed to determine what most doctors do (standard care) and show outliers. For example, scatter plots, normal distributions, and such, may be used to present outliers or deviations outside of a standard deviation. Identification of outliers can be used to identify prescriptive opportunities (or recommendations) to normalize or to bring in line the outliers by changing procedures, modifying pricing, or executing playbook tasks.

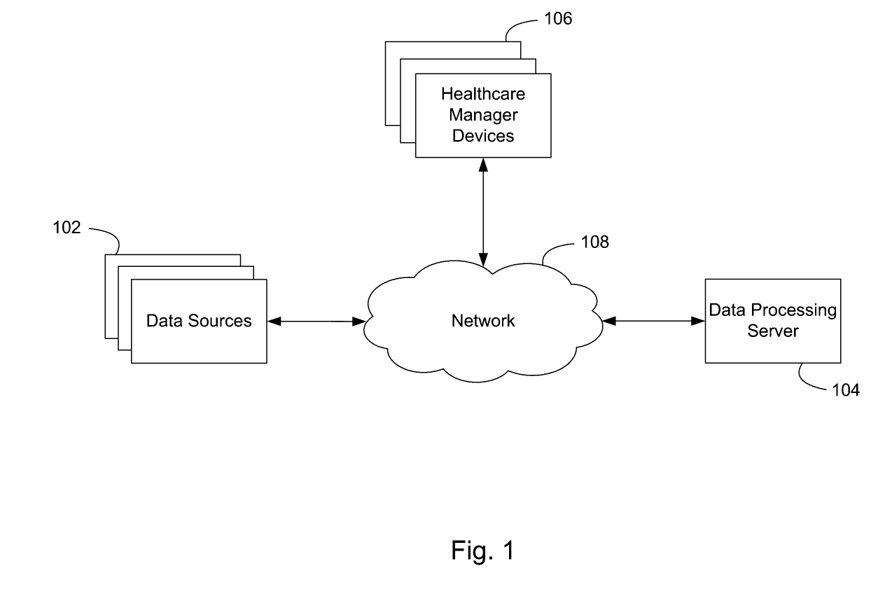

FIG. 1 presents a networked computing system according to an embodiment of the present invention. Data may be ingested from data sources 102 into data processing server 104. The data sources 102 can be any system, device, or database containing healthcare-related data (e.g., from hospitals, billing departments, government agencies, insurance and healthcare reimbursement companies, and pharmacies, etc.) and operable to transmit the healthcare-related data over network 108 to data processing server 104. Data from the data sources 102 may include electronic medical records, paid claims data, general ledger data, beneficiary data, drug data, lab data, admission, discharge and transfer data, etc. The data from data sources 102 may be in any and in disparate kinds of data formats. Receiving data from data sources 102 may include establishing connections or linking the data processing server 104 with a given account, server, directory, system, interface, etc. Data processing server 104 is operable to periodically retrieve or poll data sources 102 to collect data for generating predictive and prescriptive opportunities, and provide advanced analytics for enterprise planning and execution (along with surveillance of current operations) by healthcare manager devices 106. That is, useful and meaningful output is generated from the data collected by the data processing server 104 and the output is served to the healthcare manager devices 106, for example, via software as a service (“SaaS”).

Data processing server 104 may comprise, for example, a server computer or any other system providing computing capability. Alternatively, a plurality of data processing server 104 may be employed that are arranged, for example, in one or more server banks or computer banks or other arrangements. For example, a plurality of data processing server 104 may comprise, a cloud computing resource, a grid computing resource, and/or any other distributed computing arrangement. Such data processing server 104 may be located in a single installation or may be distributed among many different geographical locations. Even though the data processing server 104 is referred to in the singular, it is understood that a plurality of data processing server 104 may be employed in the various arrangements as described above.

Healthcare manager devices 106 may comprise computing devices (e.g., desktop computers, terminals, laptops, personal digital assistants (PDA), cell phones, smartphones, tablet computers, or any computing device having a central processing unit, memory unit, and network interface capable of connecting to a network). The devices may also comprise a graphical user interface (GUI) or a browser application provided on a display (e.g., monitor screen, LCD or LED display, projector, etc.). Healthcare manager devices may also include or execute an application to communicate content, such as, for example, textual content, multimedia content, or the like. A healthcare manager device may include or execute a variety of operating systems, including a personal computer operating system, such as a Windows, Mac OS or Linux, or a mobile operating system, such as iOS, Android, or Windows Mobile, or the like. A healthcare manager device may also include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples.

Network 108 may be any suitable type of network allowing transport of data communications across thereof. The network 108 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from device may be encrypted using, for example, the Advanced Encryption Standard (AES) with a 256-bit key size, or any other encryption standard known in the art.

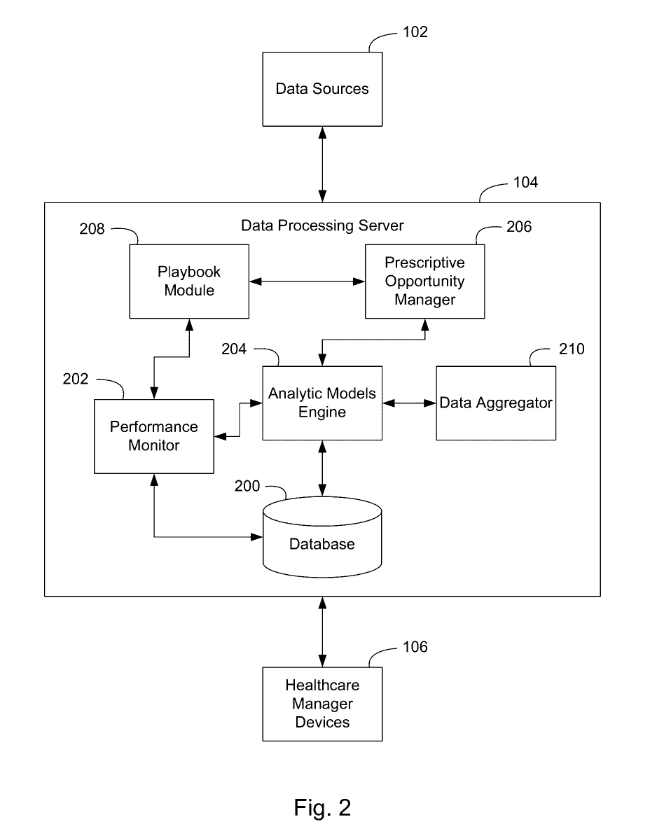

FIG. 2 presents a dataflow diagram of a data processing server according to an embodiment of the present invention. The data processing server 104 is configurable to provide features such as financial planning to monitor reimbursement contract performance and forecasting, clinical operational and financial opportunity generation, and data-driven targeted opportunities to healthcare manager devices 106 based on data aggregated from data sources 102 (and optionally from healthcare manager devices 106). Data processing server 104 includes database 200, performance monitor 202, analytic models engine 204, prescriptive opportunity manager 206, playbook module 208, and data aggregator 210. Data aggregator 210 is operable to extract healthcare data such as health service transactions, patient medical data, physician data, health plan data, provider contract data, lab data, pharmacy data, market trend data, reference data, payment data, and reimbursement data from data sources 102 and/or healthcare manger devices 106 for identifying care events (e.g., treatments, visits and procedures of patients). Data and output of logic from the components of data processing server 104 may be rendered to the healthcare manager devices 106 in a web-based feature or in a software application or cloud computing service. In one embodiment, data processing server 104 may include a multitude of tools that can be provided to healthcare manger devices such as, for example, a search tool, a statistical scoring tool, an access configuration tool, an interactive assessment tool, a recommendations tool, a storage tool, a feedback tool, an expert advice tool, a web recording tool, a market research tool, a project management tool, a prototype tool, a demonstration tool, a connect and recommend tool and a mobile tool. Users of healthcare manager devices 106 may access data processing server 104 and its associated tools via, for example, an online portal. The tools available to the users at the online portal may be a customized set of tools. For example, the users may configure the online portal by purchasing access to tools from an ala carte menu of tools. Data processing server 104 may determine the tools available to the users based upon, for example, a user subscription level, the industry, or the type of user.

Analytic models engine 204 is configurable to run and execute analytical software and logic using data from the data sources 102 and healthcare manager devices 106. The analytical software and logic may include data mining, machine learning, and “big math” instructions or code to identify cost efficiency and where improvements may be made in quality of care and savings. For example, data may be executed according to cost and quality distribution model instructions to determine how individual physician practices are currently performing and how their performance could be improved in certain areas. A comparison of episodes can be generated as analytic data output from analytic models engine 204 for the purposes of managing care and resources. Database 200 is operable to store the analytics data from analytic models engine 204. Analytic data may include input/output variables generated by analytic models engine 204 based on data from data sources 102 as described. Database 200 may contain a copy of analytical data that facilitates decision support.

The analytics models engine 204 may then analyze care events to determine whether they belong within certain episodes of care. Identifying episodes include determining related conditions as discrete episodes or packaged as a cluster. A given episode may include multiple, interrelated conditions that are often treated concurrently by a physician, clinic or hospital. Data may be downloaded from insurance companies or other agencies and used to configure or train (using machine learning) analytics models engine 204 on how to identify and group care events into episodes of care. Analytics models engine 204 may also identify opportunities from factors that lead to quality of care, cost-savings and revenue opportunities.

An episode of care may be narrowly or broadly described as a group of related services. For example, an episode of care can include a set of clinically related services for a patient for a discrete diagnostic condition from the onset of symptoms until treatment is complete. For example, the grouping of related services may be adjusted for patients who have multiple, co-occurring chronic conditions and are treated in many care settings. Additionally, the number of different care settings (e.g., inpatient, physician office, home health, etc.) may be considered when forming episodes. The number of settings involved in episodes can be varied both within episodes related to a particular condition and between episodes related to different conditions. Episodes of care identified by the analytics models engine 204 can be stored and indexed along with details for each item of care (e.g., care type, condition, patient information such as age, weight, race, gender, etc., cost of care, reimbursement/claim payment, care location, date/time of care, assigned physician/care provider) in electronic storage memory or in database 200.

Similarities and variations may be observed for a number of physicians and care providers involved in the management of episodes via analysis by the analytic models engine 204. According to one embodiment, variations between quality of care and cost associated with different physicians or care providers according to episodes may be determined by analytic models engine 204. Identifying variation may reduce undesired variations in practice patterns and patient risk factors. If practice patterns and risks are not controlled for, unintended consequences could occur in episode care for either payment or performance measurement. Determining the variability of episodes includes calculating the cost of episodes and comparing for likeness based on different dimensions and metrics. Analyzing the variations may also include determining root cause drivers of variations and identifying prescriptive opportunities to minimize the variations. Variations in episodes of care could be due to a variety of factors including 1) variation in patterns of care among providers managing patients with the same condition, 2) heterogeneity in the clinical condition of the patient (e.g., severe pneumonia versus mild pneumonia), and/or 3) random variation. By minimizing variations, optimal and/or standardized quality of care and costs can be provided by the physicians and caregivers. Analytic models engine 204 may also compare data from data source 102 with corresponding data based on standards or criteria according to clinical guidelines for specific conditions and treatment of conditions. The comparison may be used to calculate optimal clinical pathways or solutions to minimize variation.

Data used to analyze episodes of care may be normalized for differences among patients by factors such as age, race, location, weight and gender. In another embodiment, patients may be risk adjusted and assigned a health risk scoring. Health risk scoring comprises a risk adjustment based on a collection of data from insurance claims and clinical diagnoses for all enrollees in participating health plans or provider organizations that is used to provide individuals with an evaluation of their health risks and quality of life. For example, if the average risk score for the overall population is defined as 1.0, a healthy young man might receive a score of 0.4 based on historical claims data, while a young woman with asthma might be scored at 1.5, and an older person with diabetes might be scored at 2.3. Health risk scoring may be calculated based on demographic characteristics (e.g., age, sex, race), lifestyle (e.g., exercise, smoking, alcohol intake, and diet), personal and family medical history, physiological data (e.g., weight, height, blood pressure, and cholesterol), attitudes and willingness to change behavior in order to improve health. There may be a range of different scoring available for adults and children while some may even target specific populations. For example, seniors may be rated based on their ability to perform daily activities. Others may include health-care access, availability of food, and living conditions.

The prescriptive opportunity manager 206 may analyze the variations (especially outliers or variations outside of a specific standard deviation) from the analytic models engine 204 to determine corrective actions to minimize the variations. Corrective actions may be activities that can be pursued to achieve or improve certain variables such as savings or quality of care. Prescriptive opportunity manager 206 is able to recommend prescriptive opportunities for improving variables such as quality and cost by recommending actions such as terminating physicians, employing fewer and lesser expensive procedures, diagnostics, and medicine, and cease or avoid referring to certain physicians. For example, prescriptive opportunities may be based on avoidable clinical events and procedural utilization. Avoidable clinical events can include identified admissions, readmissions, and complications that may represent opportunities to improve care coordination. Opportunities may be calculated per physician, per clinical pathway, per advisor (e.g., opportunity type), per value based contract (e.g., cohort of accountable physicians), and per risk bearing entity. These events, which lead to extra interventions, longer patient stays, or more illness, are not expected consequences of the care performed. They potentially could have been avoided if the physicians performing expensive episodes performed more like the lower cost physicians. Procedural utilization may be an assessment of the specific choices made by attributed physicians (individual with the most direct influence over an episode of care, e.g., surgeon who performs a heart surgery) and a primary care provider of procedures while delivering care in an episode relative to other recipients of medical care of similar risk.

Analytic output data generated from analytic models engine 204 may be used by performance monitor 202 to generate data for display of comparisons, distributions, risk, expected costs, and an optimal intersection between cost and quality to healthcare manager devices 106. Analytic models engine 204 further includes advisor logic (not illustrated) that may be presented in a user interface as digital consultants. The advisor logic may emulate a panel of experts (e.g., using artificial intelligence) providing insights and direction to organizations where each advisor logic reviews historical data and focuses on a unique set of best practices and metrics. The advisor logic may also be presented with prescriptive opportunities for inclusion in a playbook. A playbook may include a virtual or computerized task list that may be provided along with the analytics (e.g., in an advisor logic) for suggesting actions to be taken to improve certain performance metrics such as quality of care and costs. Tasks from a playbook may be prescribed to and carried out by ACO's or healthcare organizations to modify medical practices and behavior. Examples of playbook tasks may include terminating physicians that are too expensive, prescribe less and lesser expensive procedures, diagnostics, and medicine, and advise others within a network not to refer to more expensive physicians.

Performance monitor 202 is operable to generate a variety of reports and charts of, for example, contract financial performance, clinical performance, and operational performance. Performance charts can be generated to identify performance vs. goals and identify areas where action should be taken. A summary view of how the organization is performing across all of its risk-based contracts can be tracked by the performance monitor 202. The performance monitor 202 may show complex actuarial forecasts in such a way that the operator can quickly understand whether a particular risk based contract is going to achieve savings or if they will miss them and by how much.

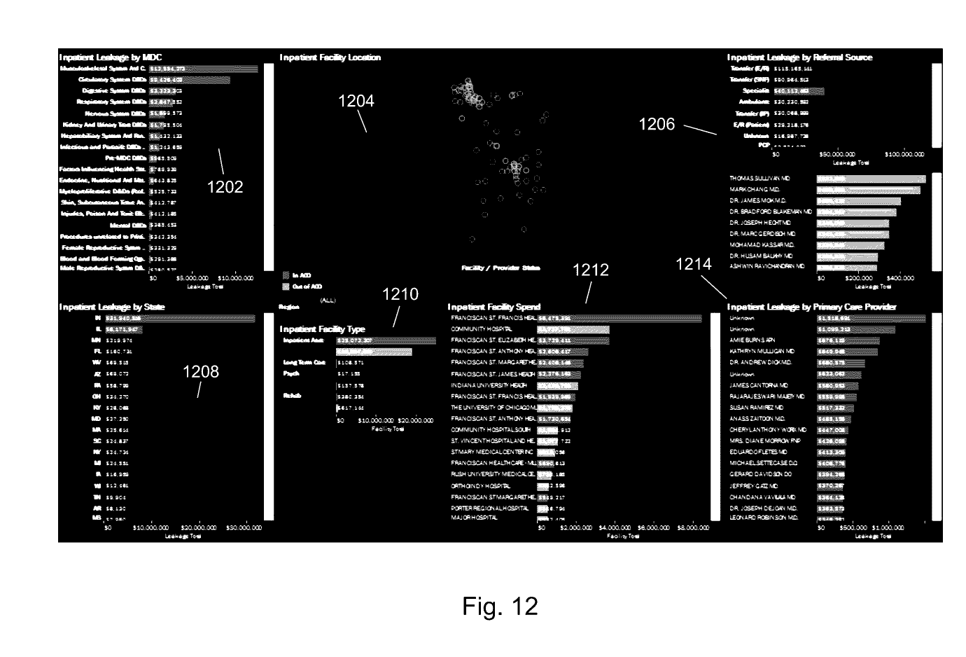

The performance monitor 202 may provide analytics and/or performance data to an organization in an overall performance summary comprising a combination of physician performance, value based reimbursement contract performance, network performance, and clinical pathway episode performance, which are described in further detail with respect to the description regarding FIG. 12C. The analytics data may be transmitted to healthcare manager devices 106 and presented in charts, graphs, visual animations, videos, renderings, spreadsheets or any other file layout or format. An organization can view diagnostic and financial performance summaries of how the organization is currently performing, and future trends, with or without playbook intervention.

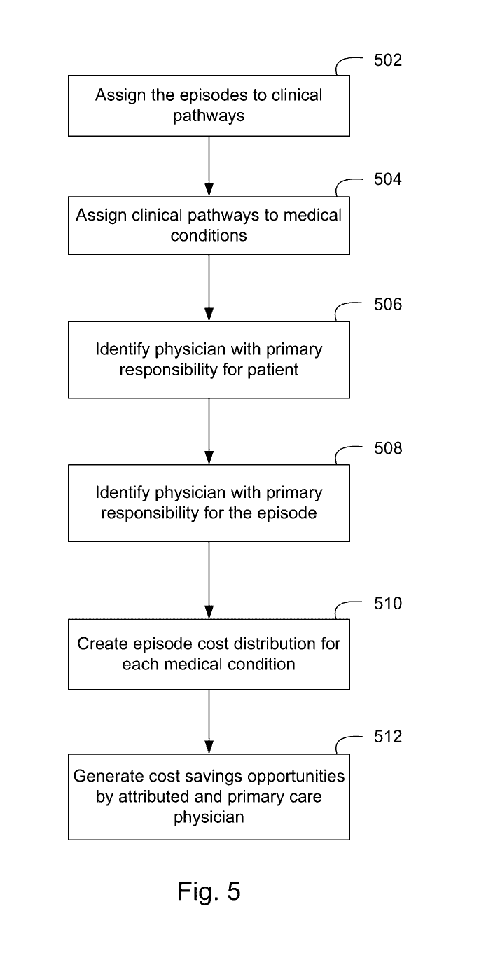

Prescriptive opportunities may also be provided along with performance data to aid decision making. A value amount of improving performance to the mean or the average can be provided in a performance chart or report by performance monitor 202. Prescriptive opportunities may be generated using historical performance data based on data (e.g., current contract rates or prices) retrieved from data aggregator 210 and performance monitor 202. Trends emerging from this data can be used to aid in avoiding mistakes or notice gaps in care that may have gone otherwise unnoticed. Opportunities can be extrapolated from peer performance, physician performance, patient risk, and a number of other factors. Performance monitor 202 is able to present prospective opportunities data highlighted by analytics models engine 204, and in which advisor(s) those opportunities reside. For example, opportunities can be presented in one of many advisor logics from the analytics models engine 204 such as clinical advisor, physician advisor, network referral advisor, and inpatient advisor, which are described in further detail with respect to the description of FIGS. 5-10. Opportunities are proactively identified and displayed in each advisor so as user can easily view, select and assign them for implementation.

Playbook module 208 is operable to incorporate financial and quality forecasting, generate prescriptive opportunity scripts, provide planning and execution strategies, generate financial operating plans to meet organizational goals, facilitate work assignment and accountability, and model the financial impact of the savings opportunity realization on the underlying contract. A playbook campaign may be generated using playbook module 208. Advisor logic(s) may provide savings opportunities that can be added (by means of scripts generated from the playbook module 208) to the playbook campaign. A playbook campaign may include a collection of prescriptive opportunities that a given organization has decided to operationally pursue in order to realize a value associated with an opportunity generated by an advisor logic from analytic models engine 204. Opportunity scripts (or “plays”) may be added to the playbook to realize, for example, the value of a particular savings opportunity recommended by an advisor logic. A play may include data instructions for transmission to or use by management software and/or systems for recommending specific actions to realize the savings. A play can be as narrow as counseling a single physician within a single clinical pathway about an avoidable clinical event, to as broad as advising a plurality of primary care physicians to alter their referral patterns across multiple clinical pathways. Other examples include: the termination of physicians that are too expensive; prescribe less and lesser expensive procedures, diagnostics, and medicine; and advise others within a network not to refer to more expensive physicians, and any other actions that may be taken to improve performance metrics.

Play campaigns may be configured to include a defined savings amount associated with them. A user can elect to enter an expected capture rate percentage, e.g., between 0-100%, to adjust an expected savings or improvement from a given play. Each play selected for inclusion in a campaign can be tracked to determine a total savings or quality of care improvement for the selections. A counter may update the total savings with every additional selection or deselection made to the campaign. For example, an attributed physician may be assigned a “physician value” that is representative of a sum of the savings between the attributed physician and all of the primary care providers or a filtered/selected list of physicians who share episodes with the attributed physician. An advisor logic may monitor selected physician values which are added to the playbook campaign as selections of physicians are made. By selecting an opportunity using an advisor logic and adding some or all of plays associated with the opportunity into a playbook, a user can observe the financial impact of executing on a value of savings or improvement associated with the opportunity.

The system may further simulate results if one or more given executions from the playbook are implemented. Playbook module 208 may communicate with analytic models engine 204 to model or simulate the impact scripts added to a playbook against current performance data. Actions from a playbook may further include indications of how realizable a desired goal can be obtained by executing a playbook item according to metrics. For example, a savings feature according to Medicare Shared Savings Plan (MSSP) may be provided to analyze paid claim data, EMR, patient data, etc. to determine how achievable and/or how to achieve (via playbook) a share of benchmark savings below a savings threshold. Once a campaign has been created and configured for implementation, it may be monitored by performance monitoring 202 in accordance to related tasks. A persistent collection of metrics may be saved in the playbook and can be configured as trackable events with a prescriptive goal. Specific advisor logic may track a given set of information associated with a particular playbook campaign.

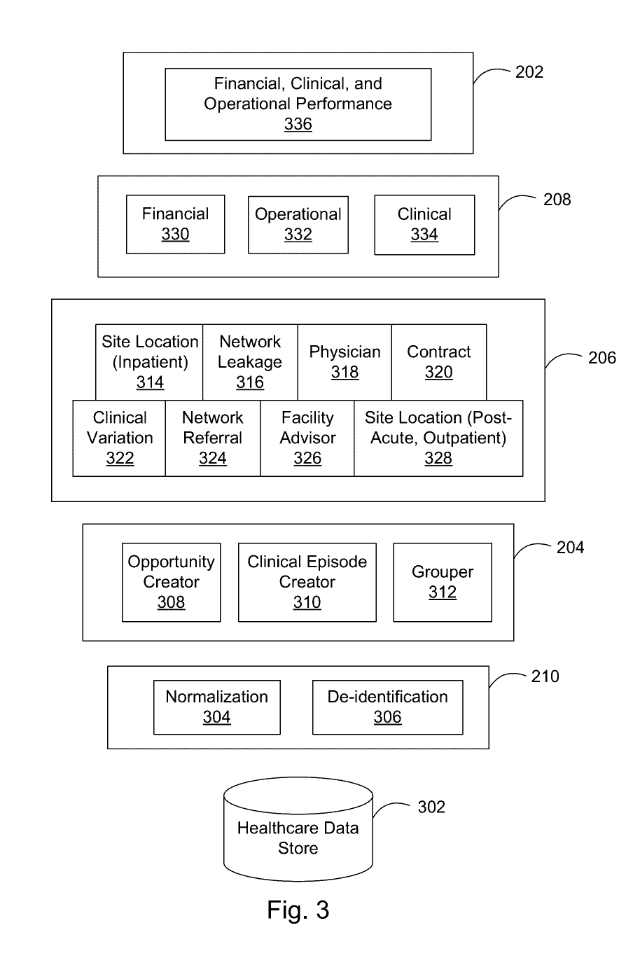

FIG. 3 presents a component diagram of a computing system according to an embodiment of the present invention. Data aggregator 210 includes a normalization processor 304 and a de-identification module 306. De-identification module 306 is operable to retrieve healthcare data from healthcare data store 302 and remove identification information from the healthcare data to safeguard sensitive information and keep the data confidential. Normalization processor 304 may then normalized the data for differences among patients by factors such as age, race, location, weight and gender.

Analytics models engine 204 includes opportunity creator 308, clinical episode creator 310, and Grouper 312. Opportunity creator 308 is operable to create opportunities to be used by advisors in prescriptive opportunity manager 206. Clinical episode creator 310 may determine episodes of care for given types of patient conditions, which may also be used by certain advisors. The clinical episode creator 310 may be communicatively connected to grouper 312. Grouper 312 includes instructions for patient classification and quality reporting that adjusts for both severity of illness (SOI) and risk of mortality (ROM) when determining the most appropriate APR DRG (all patients refined diagnosis related groups—a classification system that classifies patients according to their reason of admission, severity of illness and risk of mortality). Such grouping can then be used for financial analysis through analytics. For example, grouper 312 may be configured to assign patient records to inpatient or outpatient groups, evaluate the accuracy and completeness of clinical data, identify potential coding errors, check for medical necessity of outpatient claims, and verify expected reimbursement. Grouper 312 may provide Medicare and non-Medicare grouping, editing, and reimbursement calculations for inpatient and outpatient claims data. The grouper 312 may also be integrated with other information systems and stay current with federal and state regulations. An example of software comprising grouper 312 may be 3M™ APR DRG Grouper Software.

Prescriptive opportunity manager 206 includes advisor logic for site location (inpatient) 314, network leakage 316, physician 318, contract 320, clinical variation 322, network referral 324, facility advisor 326, and site location (post acute, outpatient) 328. Advisor logic may use opportunities created by opportunity creator 308 and episodes from clinical episode creator 310 to recommend plays for adding to playbook campaigns to improve cost of care, savings, operation, revenue, etc. Each advisor may correspond to a variety of business aspects that can group opportunities into defined work efforts (e.g., within a playbook campaign) that can be assigned to individuals within an organization.

Site location 314 includes inpatient advisor logic operable to analyze the relationships between primary care physicians and attributed physicians for treating specific patients which required an inpatient admission. A physician can be analyzed by the inpatient advisor logic based on how they manage patients with different risk profiles. An inpatient advisor logic may identify attributed physicians whose episode costs seem to indicate an over-utilization of inpatient services. The inpatient advisor logic may generate detailed metrics for identifying potential drivers to over-utilization and stratify physician performance by the risk class (e.g., severity of illness burden) of the patients they treated.

Inpatient advisor logic can look at episodes which required an inpatient admission and compares the episodes to inpatient benchmarks. Inpatient benchmarks may be created by comparing spend, admissions, and utilization for all physicians who have treated patients with similar diagnoses and comorbidities. Physicians who are routinely above benchmarks may be evaluated on their facility usage and inpatient trends. Plays may be recommended for adding to a playbook campaign to, for example, reduce readmission by finding attributed physicians with high savings and high admissions or episodes to rehabilitate. Physicians with extra costs in these areas can be identified as higher savings opportunities.

Network leakage 316 includes network leakage advisor logic operable to analyze factors that contribute to out of network care. Exemplary factors include major diagnostic categories (MDC), leakage by state, region, referral source, primary care provider, facility location and type. Network leakage 316 can identify patient behavior in and outside of health care systems' networks across services and procedures, physicians and practices, and geographies. Plays may be recommended to decrease the amount of care provided outside of the network. For example, network leakage 316 may pinpoint providers in a network whose referral patterns are leading to patient leakage and recommend a play to change this behavior by educating in-network providers about their referral patterns. In another example, the network leakage advisor logic may identify where patients are receiving care out-of-network and identify opportunities to improve retention across service lines, providers and geographies.

The network leakage 316 may further identify network leakage by gathering a collection of trigger events from processed claims. In patient index admissions can be common trigger events but other claims can also be used. A time series analysis of the claims may be performed to determine trigger events (e.g., spanning from 60 days prior to the start of the trigger event to the end of the trigger event). For example, referring events can be identified as the proximate cause of the trigger using a set of rules where: if a claim of the same type (e.g. inpatient acute facility) but for a different provider is found that ends within 36 hours of the start of trigger event is found, that claim is considered the referring event; otherwise, if a claim for a transportation services provider is found that ends within 36 hours of the trigger event, that claim is considered the referring event; otherwise, if in the previous 60 days a professional claim is found for a provider who also provided services during the trigger event and the provider does not meet certain exclusion conditions, then that claim is considered the referring event—if more than one provider is found, then the most recent claim for provider with the plurality of services is considered the referring event; otherwise, if a claim for an emergency services provider is found that ends within 36 hours of the trigger event, that claim is considered the referring event. Services provided during the triggering event are aggregated and classified based on the network relationships of the provider delivering them, e.g. in or out of network. The ratio of each classification to the total spend may then be reported.

Physician 318 includes physician advisor logic operable to provide an entire scope of prescriptive opportunities, for each attributed physician, from clinical pathways and the other advisor logics, and summarize playbook campaign engagement of the physician. The physician advisor logic may also receive a summary of other advisors for avoidable complications, procedure, network referrals, and inpatient performance. Physician advisor logic is operable to aggregate savings from clinical advisor logic, network referral advisor logic, and inpatient advisor logic, etc. Each individual physician may be analyzed to assess their care and cost statistics and performance in comparison with other physicians or group of physicians. Plays may be recommended for adding to a playbook campaign based on a focus on individual physicians.

Contract 320 includes contract advisor logic that may analyze payer, size and performance of value based reimbursement contracts vs. goals and identify areas where additional action should be taken. A contract's performance may be defined by a yearly operating plan and benchmarks for the contract. The contract advisor logic may perform financial contract forecasting using multiple inputs based on identified savings opportunities generated by various advisors.

Financial contract forecasting may include identifying a set of opportunities that are selected or “in plan.” The opportunities can be normalized to address changes in population over time. An opportunities delivery window (e.g., rate of implementation) may be scaled by a user selected method (e.g. straight line, accelerated, lagged, population step-function) to ensure the cumulative effect of actions in each period is recognized. Forecasting is adjusted per period to reflect each opportunity's expected contribution. As the set of opportunities are executed against over time, forecast model inputs are adjusted to reflect actual versus planned completion, including predicting the likely final level of success.

Clinical variation 322 includes clinical advisor logic operable to analyze clinically related activities observed during episodes of care and evaluates their unnecessary costs. Organizational level characterizations of over-utilized procedures or unexpected outcomes of an episode of care may be provided by the clinical advisor logic. Clinical advisor logic may detect patterns of an individual, or groups of, attributed physicians and generate an evaluation for areas of improvement ordered by cost value and available prescriptive opportunities. Plays may be generated from opportunities that may be associated with an attributed physician whose historical behavior, for example, included an avoidable clinical event or procedure in one or more clinical pathways.

Network referral 324 includes logic operable to analyze the relationships between primary care physicians and attributed physicians. Network referral advisor logic may generate data for the interface to identify referral patterns, optimize network performance, and create high performance networks. Network performance may refer to the overall cost and quality of the physicians in a given network, and the physicians visited by beneficiary patients. The network referral advisor logic may evaluate individual physicians for savings and performance metrics. The interface can be used to identify attributed physicians who are driving up care costs, and primary care providers of patients who see those higher cost attributed physicians.

Facility advisor 326 includes facility advisor logic operable to evaluate performance, generate playbook recommendations, and summarize performance of existing playbook campaigns for improving savings and operation within facilities. Plays may be recommended by facility advisor 326 for adding to a playbook campaign based on a focus on healthcare services provided in specific facilities.

Site location 328 includes post-acute/outpatient advisor logic that is operable to determine over-utilization of post-acute and outpatient services. Similar to site location 314, the outpatient advisor logic looks at episodes which required an outpatient admission and compares the episodes to outpatient benchmarks. Plays may be recommended by the post-acute/outpatient advisor to reduce outpatient utilization.

Playbook module 208 includes opportunity execution modules for financial 330, operational 332, and clinical 334. That is, financial 330, operational 332, and clinical 334 can be configured to receive financial, operational, and clinical plays from advisor logics for execution of scripts for specific playbook campaigns, respectively. Performance monitor 202 includes logic for monitoring financial, clinical, and operational performance 336. Financial, clinical, and operational results and performance associated with current operations, before execution of plays from playbooks, and after execution of plays from playbooks may be tracked and provided for graphical or numerical display on a user interface.

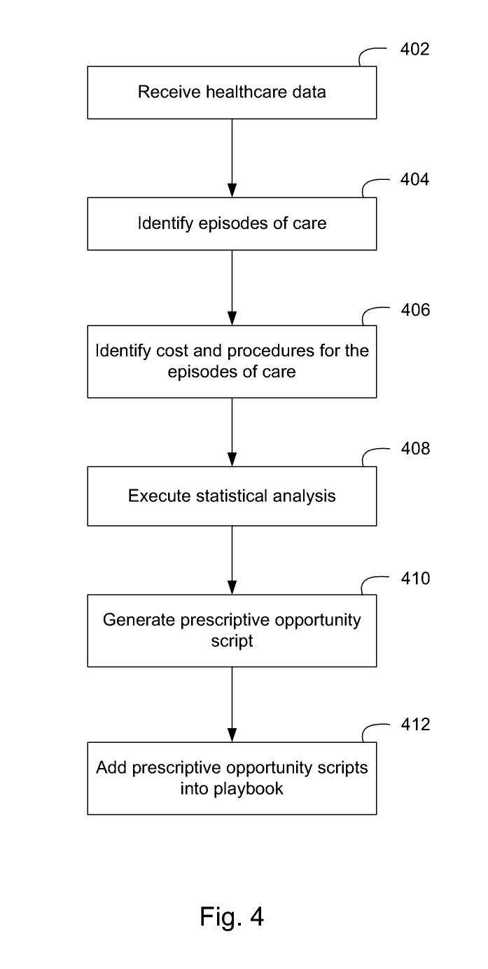

FIG. 4 presents a flowchart of a method for generating analytical data output according to an embodiment of the present invention. Healthcare data is received from data sources, step 402. The healthcare data may include data such as patient conditions, paid claims, and associated treatment information. Data sources may include systems, software, and devices from health care providers, hospitals, clinics, treatment centers, pharmacies, etc. The data may be in the form of diagnostic codes, drug codes, procedure codes, healthcare facility, user-defined, and emergency visits that are received or retrieved by a data aggregator of a data processing server.

Episodes of care are identified, step 404, from the healthcare data by the data processing server. The healthcare data can be used by the data processing server as inputs to build episode data. For example, claims are grouped into episodes of care for given types of patient conditions. Patients may be tracked to determine which visits, procedures, and care services, etc., belong to a given episode. Clusters of the visits, procedures, and care services, etc., may be formed based on instances of face to face encounters, e.g., evaluation and management (E&M) visits, surgery, etc., from the healthcare data. The clusters may define the start of an episode and extend an episode. An episode ends when no further clusters occur within a “clean period.” Non-face to face services can be considered as incidental to the evaluation, management, or treatment of the patient such as X-rays, lab tests, facility, and pharmaceuticals. Non-face to face services may not extend the date range of an episode. An episode may be determined as complete in absence of a new cluster for the condition's clean period. The more chronic a condition, the longer the clean period may be.

Cost and procedures are identified for the episodes of care, step 406, by the data processing server. An actual cost for each episode including claims in the episode (e.g., physician services, inpatient and outpatient facility services, prescription medications, and other services) and an expected cost for each episode (e.g., specialty average) are calculated. Identifying costs and procedures for the episodes of care further includes attributing responsibility to a physician for each episode. A given set of the healthcare data is associated with a physician such that statistics may be generated that corresponds to the physician's performance.

Statistical analysis is executed, step 408, by the data processing server. Executing statistical analysis may include summing the data of actual costs and expected costs for each physician and creating an actual to expected cost ratio. Physicians may be compared, within specialty, on relative cost efficiency performance based on the actual to expected cost ratio. Outlier episodes of care (e.g., not within a given standard deviation), in terms of cost or efficiency, may be identified along with the physicians responsible for the outlier episodes of care. Further description and details regarding the statistical analysis is described in further detail with respect to the description of FIG. 5.

Prescriptive opportunity scripts based on the statistical analysis are generated, step 410. The prescriptive opportunity scripts may include executable instructions generated by the data processing server that are associated with corrective actions that may be applied to outliers. The prescriptive opportunity scripts can be transmitted from the data processing server to performance management systems of healthcare manager device as a recommendation for inclusion in a playbook. Corrective actions may include for example, terminating physicians that are too expensive, prescribe less and lesser expensive procedures, diagnostics, and medicine, and advise others within a network not to refer to more expensive physicians, and any other actions that may be taken to bring the outliers “inline” or reduce the variance in care and cost. The executable instructions may also be analyzed by the data processing server for simulating the corrective actions for rendering to the performance management system.

Generating prescriptive opportunity scripts may further include identifying and monitoring savings or improvement opportunities by collecting a set of statistically significant variations or deviations, identifying the participant physicians involved in or who can affect the variations by recording the identity of the attributed physician for the episode, and recording the identity of the primary care physician for the episode. Contract terms may be analyzed and a return can be calculated from reducing or eliminating the identified variations. Potential savings associated with eliminating each variation are then identified. The savings amount may be adjusted to reflect the terms of the risk contract and the ease of execution associated with its elimination. Opportunity details can be saved by the data processing server for future performance tracking. The data processing server may measure current performance and predict future performance (e.g., clinical, operational and financial performance) of financial value/risk based contracts and associated work efforts defined in playbooks on a periodic basis. The effects of variance reduction efforts over time can be tracked and reported. Tracking effects of variance reduction efforts over time may include re-running the variance monitoring as new data is received (e.g., of claims), comparing the variances identified with those found in a previous run, calculating an overall change in variance, calculating change in variance by attributed physician, and calculating change in variance by primary care physician.

The prescriptive opportunity scripts are added into a playbook, step 412. The playbook may comprise a collection of one or more prescriptive opportunity scripts on a performance management system that may be selected for execution (as plays in the playbook) via a healthcare manager device to achieve certain episode-related, cost savings, or revenue goals or results. For example, episode-related goals or results may include reducing the cost of care for episodes associated with a given physician or modifying care services that are provided for certain episodes associated with the given physician. The playbook may relate episode-related goals to certain prescriptive opportunities (e.g., cause and effect) and present them as solutions or suggestions on the performance management system for reducing variance in outlier episodes. Results and performance associated with the execution of the playbook may be monitored and tracked by the data processing server and provided to the performance management system as feedback of the savings or improvements associated with the executed prescriptive opportunities.

FIG. 5 presents a flowchart of a method for performing exemplary statistical analysis of episode data according to an embodiment of the present invention. Episodes are assigned to clinical pathways, step 502. A clinical pathway may be described as a set of medical conditions that share common diagnoses and treatment patterns. Assigning episodes to clinical pathways may include identifying a sequence of diagnostic activities, identifying principal diagnosis, and identifying any major procedures performed.

A clinical pathway is assigned to a medical condition, step 504. Assigning a clinical pathway to a medical condition includes assigning each clinical pathway to an overall condition, and analyzing the episodes in each overall condition as a cohort.

A physician with primary responsibility for the patient is identified, step 506. Identifying a physician with primary responsibility for the patient includes extracting a list of physicians caring for each patient, restricting the list to those with specialties appropriate for the coordination of patient care, rank ordering the physicians based on the services provided, and assigning the patient to the highest ranked physician.

A physician with primary responsibility for the episode is identified, step 508. Identifying physician with primary responsibility for the episode includes extracting the list of physicians participating in each episode, restricting the list to those with specialties appropriate for the clinical pathway assigned to the episode, rank ordering the physicians based on the services provided, and attributing the episode to the highest ranked physician.

An episode cost distribution is created for each medical condition, step 510. Creating the episode cost distribution for each medical condition includes creating a patient demographics distribution, creating a patient risk factors distribution, creating a physician case mix distribution, creating a regional cost distribution, creating a severity of illness distribution, creating an episode triggers distribution, creating a clinical pathways distribution, and building a multivariate model that describes the expected cost of care for each episode.

Cost savings opportunities by physician are generated, step 512. Cost savings value opportunities may be calculated from medical data and provide actionable insights to their sources and causes. Generally, identifying cost savings opportunities may include taking grouped longitudinal medical claims data into episodes of care with other relevant data, and grouping them into clinical pathways. The episodes may be arranged within clinical pathway by patient risk stratifications. The resultant data can be analyzed to derive an expected value for each clinical pathway (e.g., physician clinical pathway benchmark) and then savings opportunities may be generated for each physician.

Generating cost savings opportunities by physician includes using multivariate model inputs from each episode to generate an expected cost for the episode. A physician clinical pathway benchmark may be created by collecting groups of episodes based on common clinical characteristics, removing services not clearly related to the condition from each episode, creating a multivirate regression model for each group using patient age, gender, co-morbidities, and severity of illness for the specific clinical condition as predictive variables and episode cost as the response variable, generating a credibility interval for the model outputs and score each episode, and calculating expected savings as the difference between the episode cost and predicted costs, capping the upside and downside to the credibility interval. The actual episode cost is compared with the expected cost. The variance between expected and actual costs for each attributed physician and the variance between expected and actual costs for each primary care physician are calculated. A relative performance measure for each attributed physician may then be calculated.

According to one embodiment, the method may further include identifying revenue generating of lost revenue opportunities from the medical data. For example, lost revenue opportunities may be identified by identifying trigger facility claims for a patient. The referral source for each trigger event may be identified. Claims that occurred during the trigger event can be aggregated by provider, and the providers may be mapped to specific managed care networks. Spend by network may then be aggregated to identify classes of lost revenue and the decision makes responsible for the loss. Such revenue opportunities can be calculated per facility, per facility type, per referral type, per referral source, and per major diagnostic category or body system.

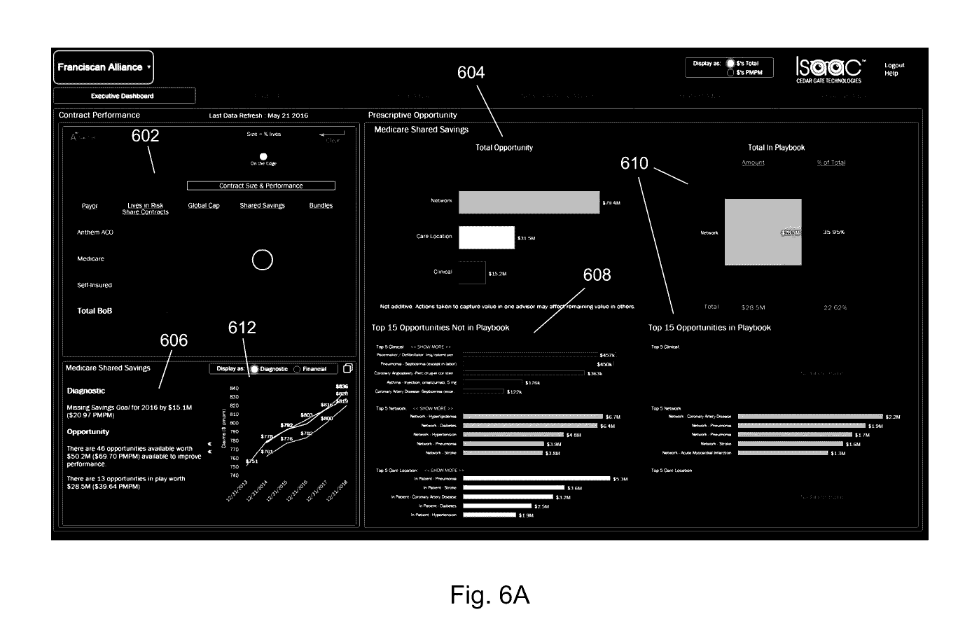

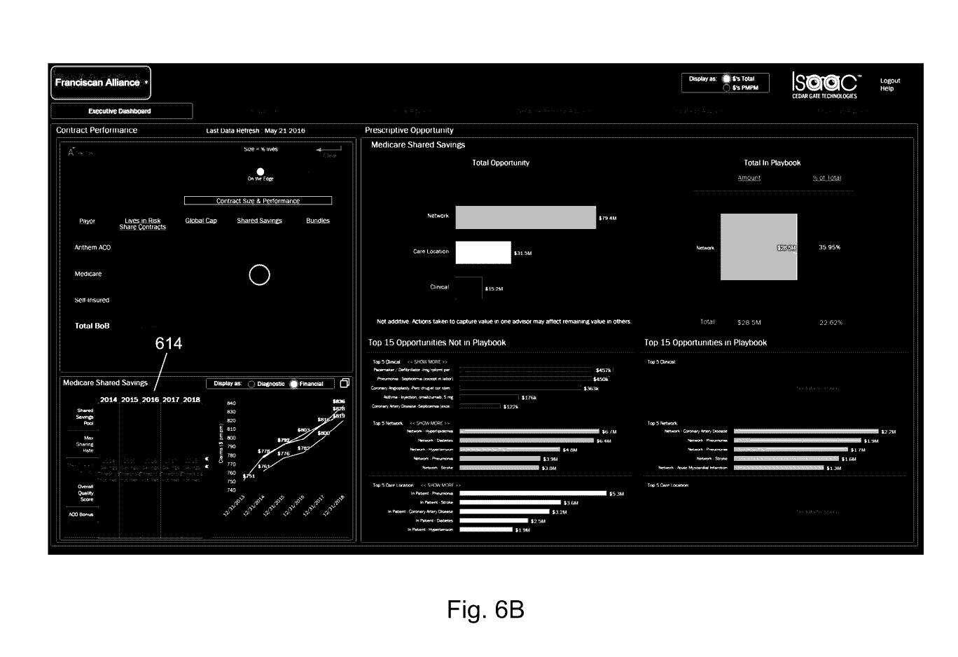

FIG. 6A presents an exemplary dashboard interface for viewing a summary of how an organization is performing across all of its risk-based contracts tracked by a system according to one embodiment. The dashboard may track an organization's overall “as-is” performance in addition to providing an actuarial-sound forecast of future performance based on current trends. A playbook area can show the user the degree to which the organization has adopted opportunity recommendations and have plays currently under way. An individual contract may be selected for viewing along with any prescriptive opportunities for that contract. The system may forecast whether a particular risk based contract is going to achieve savings or if they will miss them and by how much. The interface can also display the totals of prospective savings opportunities that analytics of the system have identified, and in which advisor (logic) those opportunities reside. Contracts can involve different patient populations and physicians, and different advisor logic may be available for each contract.

The dashboard can be configured to present a contract performance view including contract size and performance 602 and performance charts 612 to identify performance vs. goals (606) and identify areas where additional action should be taken. The contract performance view provides an indication of the payer, size, and performance of each value based reimbursement contract. A contract's performance may be defined by a yearly operating plan and benchmarks for the contract. The illustrated performance vs. goals 606 includes a goal amount for a given year or periods and opportunities available to improve performance. The dashboard also includes a window presenting opportunities not yet captured (608) in a playbook and another window presenting total opportunities 604, and total in playbook amount 610, of the overall opportunities which are currently being tracked in the playbook. According to the embodiment illustrated in FIG. 6B, performance details 614 for Medicare Shared Savings may present goals for “shared savings pool,” “max sharing rate,” “max shared savings,” “overall quality score,” and “ACO bonus” and an indication of reaching a threshold for each goal for a plurality of periods (e.g., calendar years).

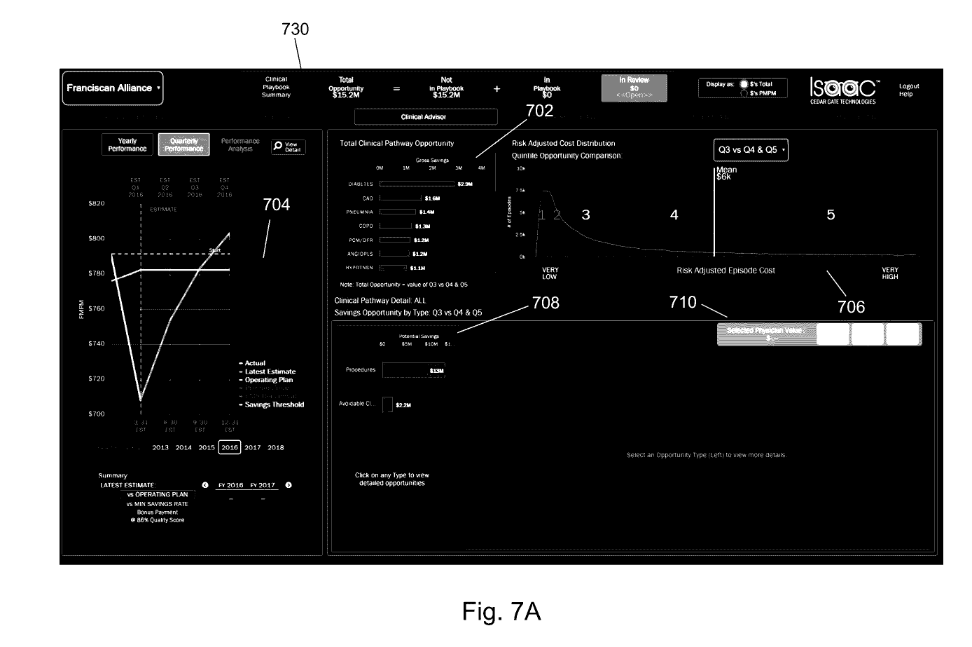

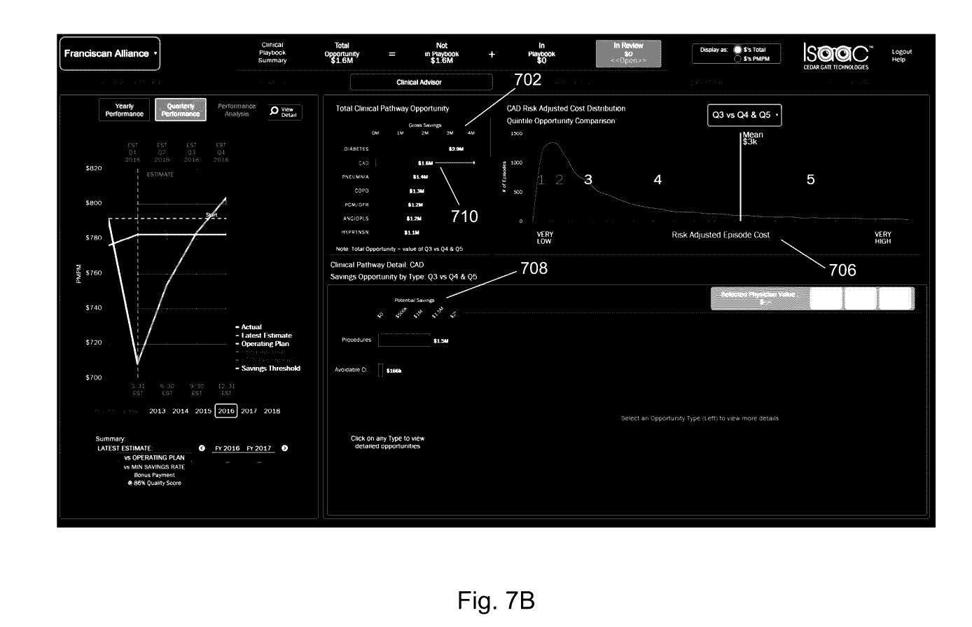

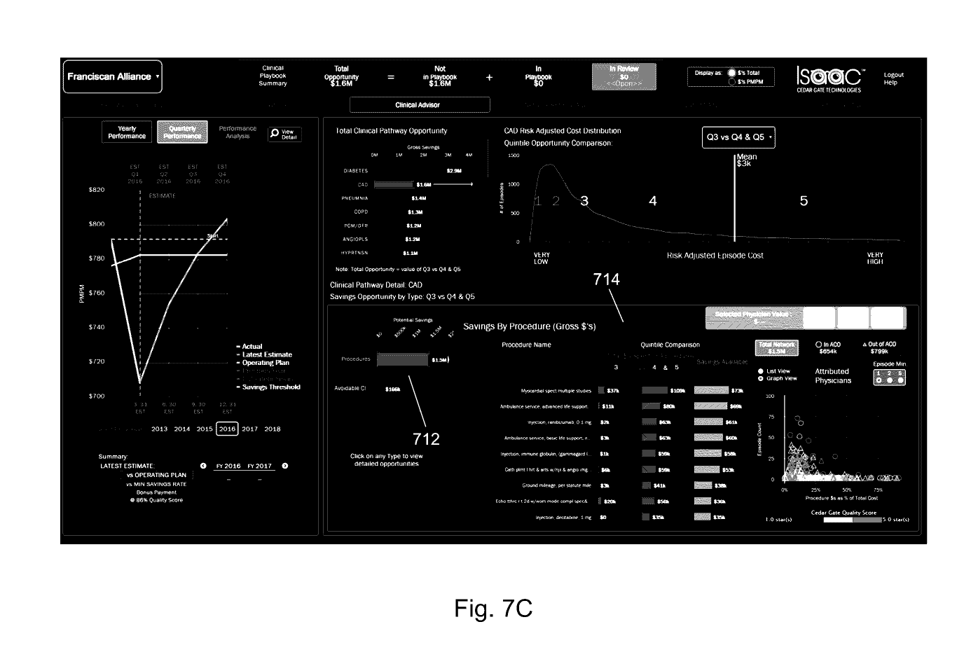

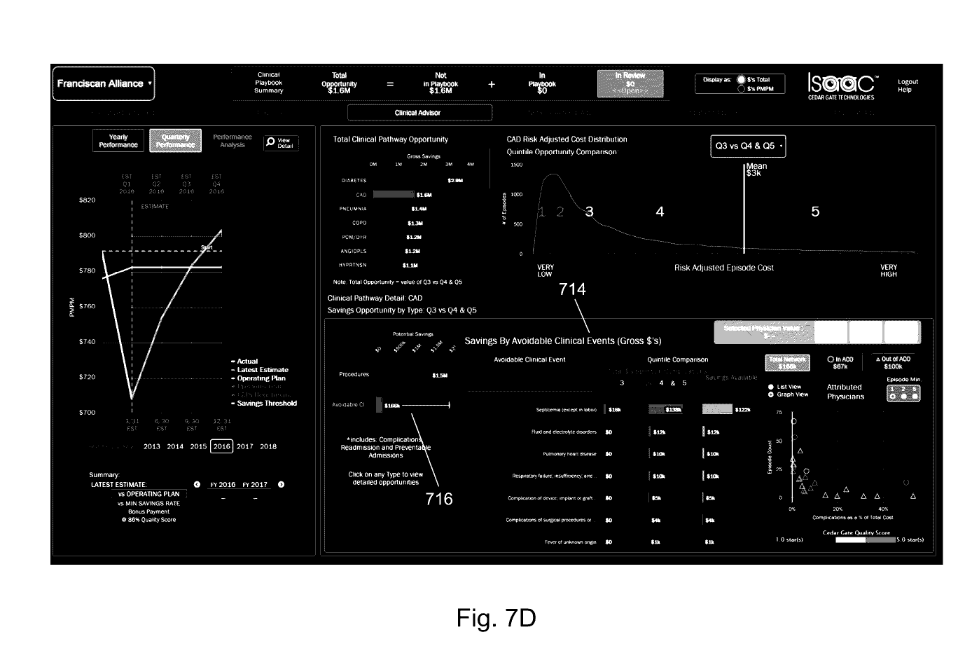

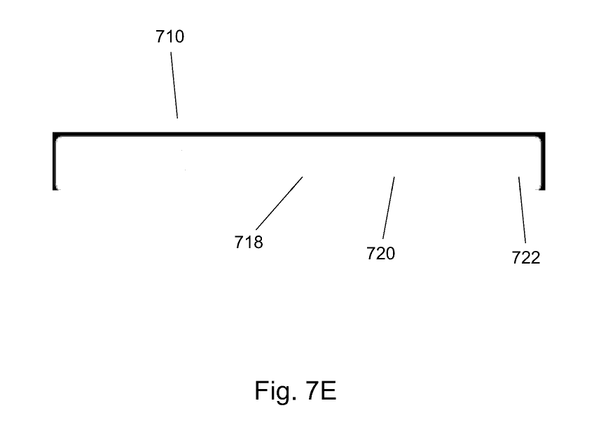

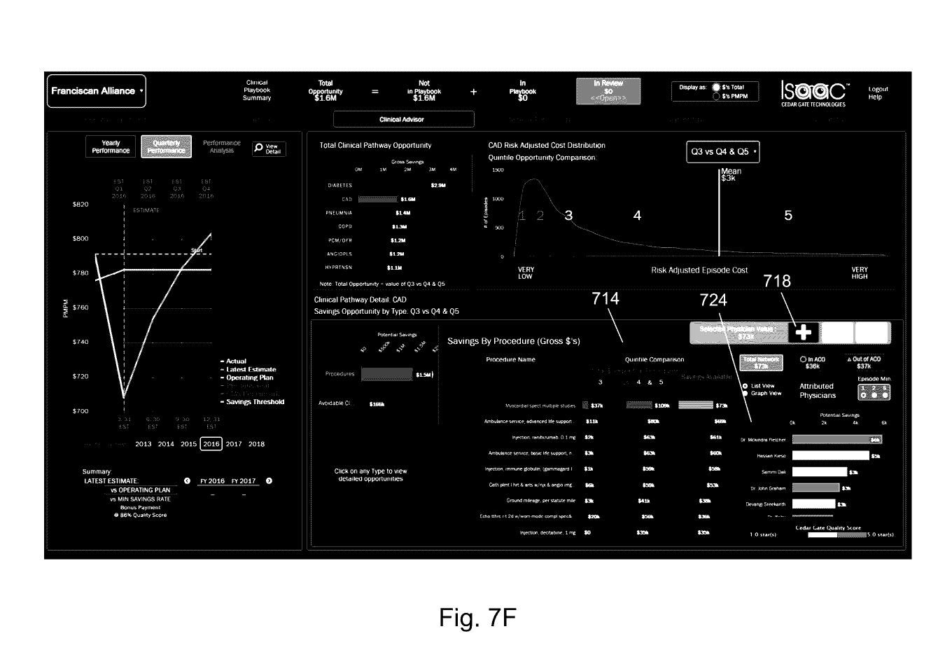

FIG. 7A-7F present an exemplary clinical advisor interface according to an embodiment of the present invention. Clinical advisor logic is operable to analyze clinically related activities observed during episodes of care and evaluates their unnecessary costs. Organizational level characterizations of over-utilized procedures or unexpected outcomes of an episode of care may be provided by a clinical advisor logic. The clinical advisor logic may generate data associated with clinically related activities and unnecessary costs incurred during episodes of care and populate the data in the clinical advisor interface. The data presented by the clinical advisor logic may be filtered to the patterns of an individual, or groups of, attributed physicians.

Clinical performance 704 presents overall actual performance and future projections including an operating plan and latest estimate plotted against a savings threshold for a defined time period (e.g., quarterly, yearly). A clinical playbook summary 730 may indicate dollar values of total opportunities, opportunities not in playbook, opportunities in playbook, and opportunities in review. A portion of the clinical advisor interface includes total clinical pathway opportunity 702 that summarizes and orders the available savings opportunity defined by clinical metrics for clinical pathway categories in order of greatest to least value. Users can select a single clinical pathway at a time to narrow the scope of their analysis. FIG. 7B presents a selection of clinical pathway 710. Based on the selection, risk adjusted cost distribution 706 and clinical pathway detail 708 provides specific data for the selected clinical pathway 710. Risk adjusted cost distribution 706, presents clinical pathway episode performance across an enterprise compared to the mean and quintiles. A quintile distribution allows users to quickly understand the distribution of the cost associated with each episode distribution across a clinical pathway. The quintiles may also be configured to include a grouping (e.g., five) of total or selected clinical pathway episodes that are assigned and ranked by risk adjusted cost.

Clinical pathway detail 708 provides an evaluation for areas of improvement ordered by cost value and available prescriptive opportunity types. Opportunity types may be selected to see its category breakdown, either across all clinical pathways or in a single clinical pathway. FIGS. 7C and 7D presents a display of savings by opportunity type 714 upon selecting opportunity type 712 and opportunity type 716, respectively. According to the illustrated embodiment, overall savings opportunities for a selected clinical pathway may be summarized into the two main categories (opportunity types) of avoidable clinical events and procedural utilization. Savings by opportunity type 714 may provide total cost spent vs. certain quantiles and an associated savings available.

Plays may be recommended for adding to a playbook campaign based on the clinical advisor logic such as selecting one or more avoidable clinical event to reduce (and storing all the physicians with identified savings for the selected events), developing clinical protocols for a clinical pathway by identifying over-utilized procedures and the physicians who perform them, and developing a physician re-education plan, and managing avoidable clinical event or procedure savings for physician(s). For example, a user may add to a playbook a play associated with an attributed physician whose historical behavior from the target quintile(s) included an avoidable clinical event or procedure in one or more clinical pathways. A list of physicians may be presented for adding to a playbook by enabling add to playbook 718 in physician value navigation bar 710, as illustrated in FIG. 7E. Physician value navigation bar 710 also includes navigational shortcuts to physician performance 720 and physician advisor 722. Physician list 724, presented in FIG. 7F, includes physicians associated with a physician savings value. One or more physicians may be selected from physician list 724 and total savings opportunity is updated with every selection or deselection.

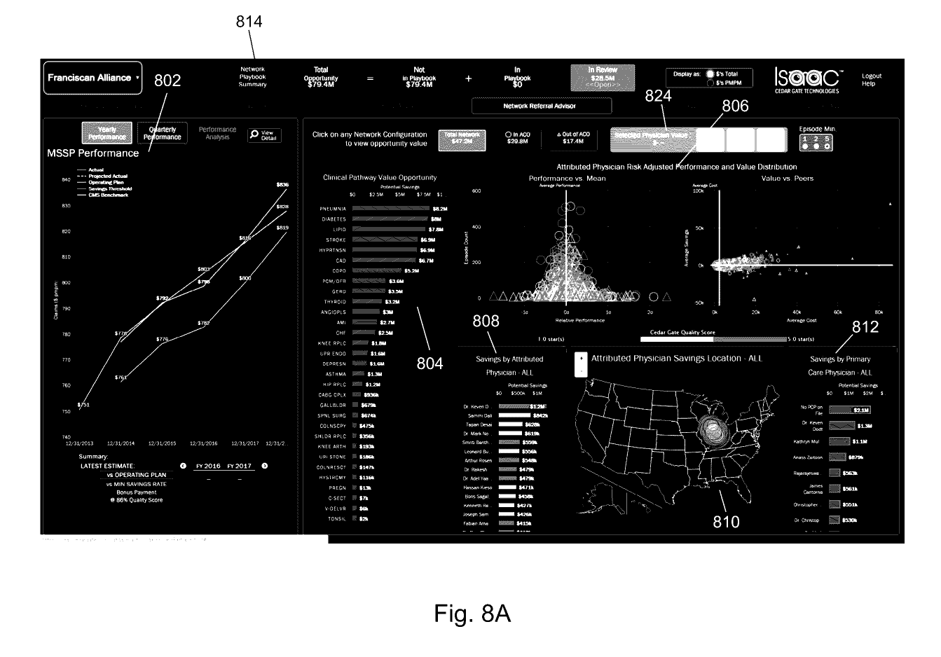

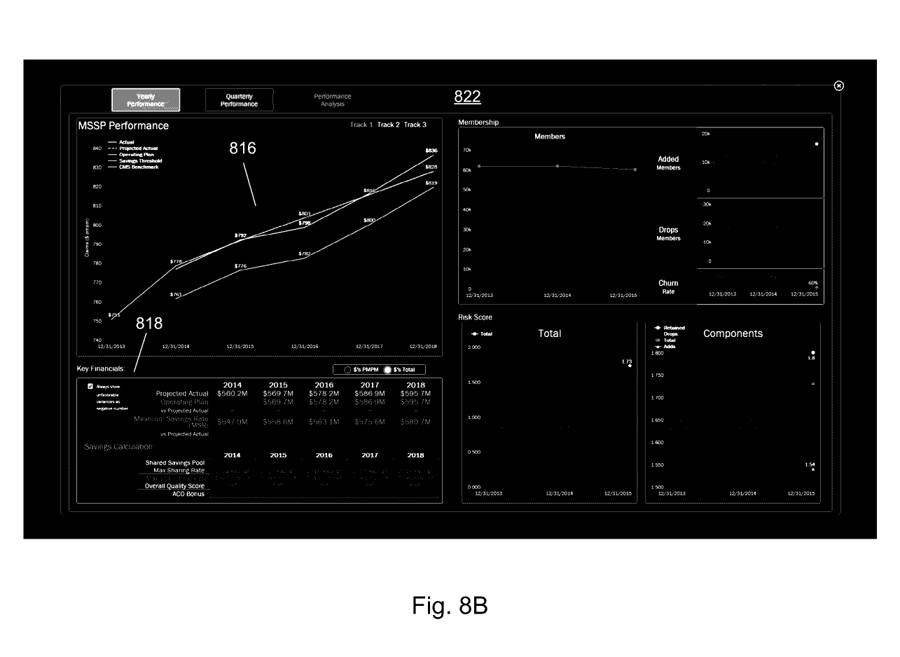

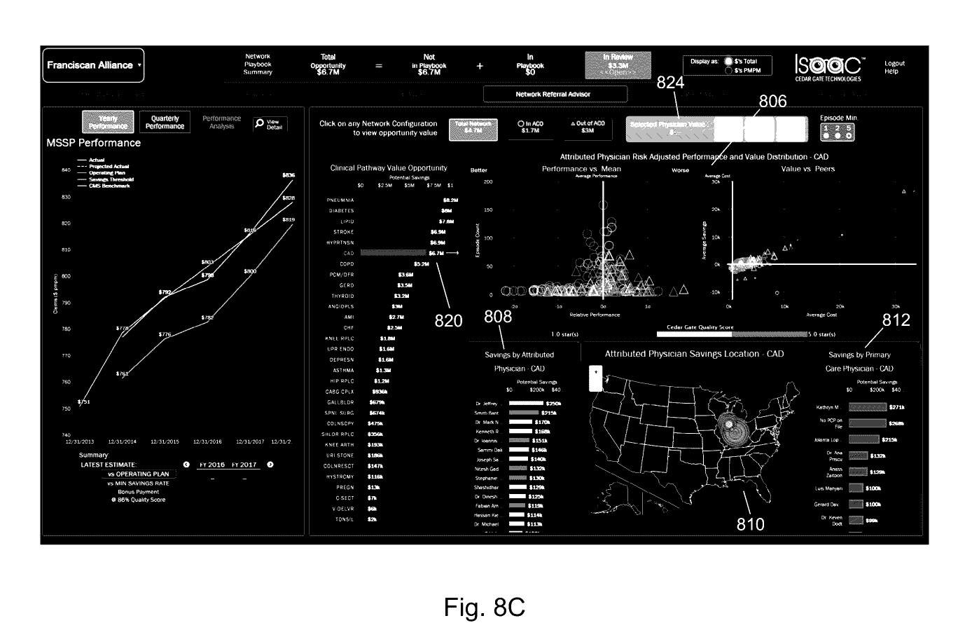

FIG. 8A-8C present an exemplary network referral advisor interface according to an embodiment of the present invention. Network referral advisor logic is operable to analyze the relationships between primary care physicians and attributed physicians. Network referral advisor logic may generate data for the interface to identify referral patterns, optimize network performance, and create high performance networks. Network performance may refer to the overall cost and quality of the physicians in a given network, and the physicians visited by beneficiary patients. MSSP performance 802 presents actual performance and future projections including an operating plan and projected performance against a savings threshold and a CMS (Centers for Medicare and Medicaid Services) benchmark for a defined time period (e.g., quarterly, yearly).

Network referral advisor logic may perform data-driven observations about overall physician performance relative to peers. In particular, using a risk adjusted total episode cost, the advisor logic may plot a physician's relative performance for all of their episodes in a given clinical pathway against all of his/her peers. Clinical pathway value opportunity 804 may summarize and sort available savings opportunities, defined by network referral metrics, for each clinical pathway in order of greatest to least value. Attributed physician risk adjusted performance and value distribution 806 includes a performance vs. mean chart that plots physicians based on a risk adjusted normalization of relative performance of all of their episodes in clinical pathways selected from clinical pathway value opportunity 804. Physicians close to the mean perform as expected are plotted close to the ‘0’ line. The greater the disparity between the expected cost and actual cost, the further from the ‘0’ line the physician may be plotted. Distribution 806 further includes a value vs. peers chart that shows the distribution of actual cost and risk adjusted expected cost. The physician's historical volume is represented in the size of the physician bubble. For example, a physician with a high average cost but better than average performance may be a physician seeing high risk patients, but managing their care well.

Network playbook summary 814 may indicate dollar values of total opportunities, opportunities not in playbook, opportunities in playbook, and opportunities in review. Savings opportunities can be identified by the network referral advisor logic by comparing the spend of different physicians on patients of similar comorbidities and diagnoses. The interface can be used to identify attributed physicians who are driving up care costs, and primary care providers of patients who see those higher cost attributed physicians. Network referral advisor is operable to present referral patterns between the primary care provider and attributed physician. If two physicians achieve the same results but their approaches have wildly different costs, it may be desirable to encourage PCPs to refer to the more “preferred” physician, or block referrals to the more expensive physician completely. Accordingly, the network referral advisor logic may identify a physician population's referral patterns, or lack thereof. For example, a high episode count between a primary care provider and a few attributed physicians might indicate that the physician actively refers his/her patients to a few trusted specialists (who the physician likely perceives as “high quality” specialists based on anecdotal information). Low episode counts and a wide spread of attributed physicians may imply that the primary care provider is not taking in active role in care coordination.

The network referral advisor logic may evaluate individual physicians for savings and performance metrics. Savings by attributed physician 808 may summarize an attributed physician's overall savings opportunity and sorts them in descending order. The savings opportunity may be based on clinical pathway and filtered by primary care physician. Attributed physicians may be selected and cause primary care physician 812 to reflect physicians and savings opportunity for beneficiaries in an ACO who have been treated by the filtered set of primary care physicians. Attributed physician savings location 810 may present locations of the attributed physicians from attributed physician 808.

MSSP performance 802 may be expanded to MSSP performance popup 822, as illustrated in FIG. 8B. MSSP performance popup 822 includes MSSP performance chart 816 and key financial data 818. MSSP performance chart 816 presents data that are substantially similar to MSSP performance 802 such as actual performance and future projections including an operating plan and projected performance against a savings threshold and a CMS benchmark for a defined time period. Key financial data 818 presents projected actual performance compared with an operating plan and a minimum savings rate. The key financial data 818 further includes an indication of reaching a threshold for “shared savings pool,” “max sharing rate,” “max shared savings,” “overall quality score,” and “ACO bonus” goals over a plurality of periods (e.g., calendar years).

Users can select one or more clinical pathways at a time from clinical pathway value opportunity 804 to narrow the scope of their analysis. FIG. 8C presents values for attributed physician risk adjusted performance and value distribution 806, savings by attributed physician 808, attributed physician savings location 810, and savings by primary care physician 812 for a selected clinical pathway 820.

Plays may be recommended for adding to a playbook campaign based on the network referral advisor logic such as storing physicians that are preferable PCPs to refer to for a set of diagnoses, selecting physicians who can be rehabbed to change their behaviors and achieve savings, and removing physicians from a network by adding them to a “Do Not Refer” list. Physicians may be selected to a playbook by using physician value navigation bar 824.

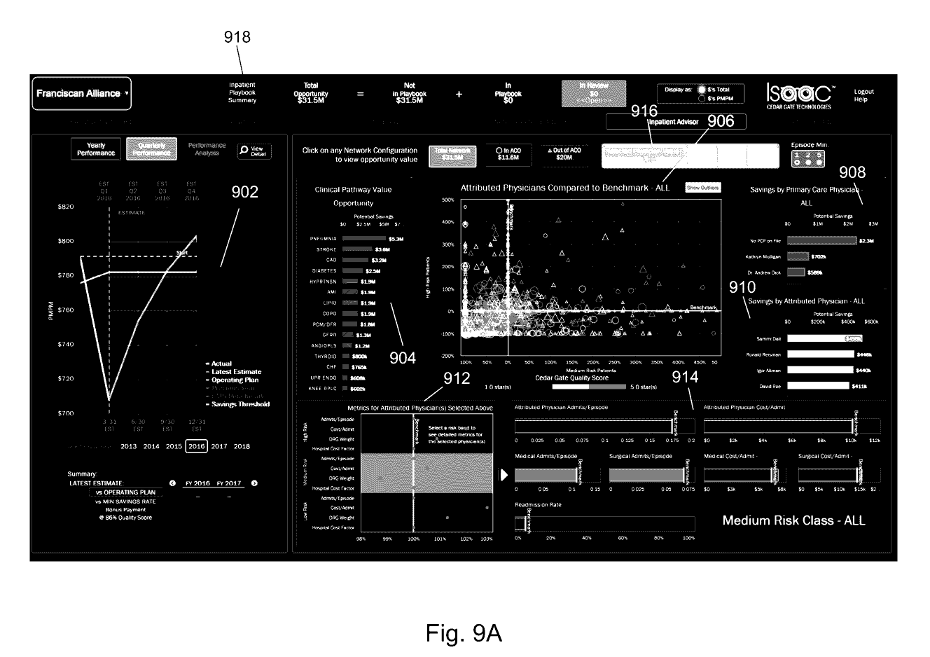

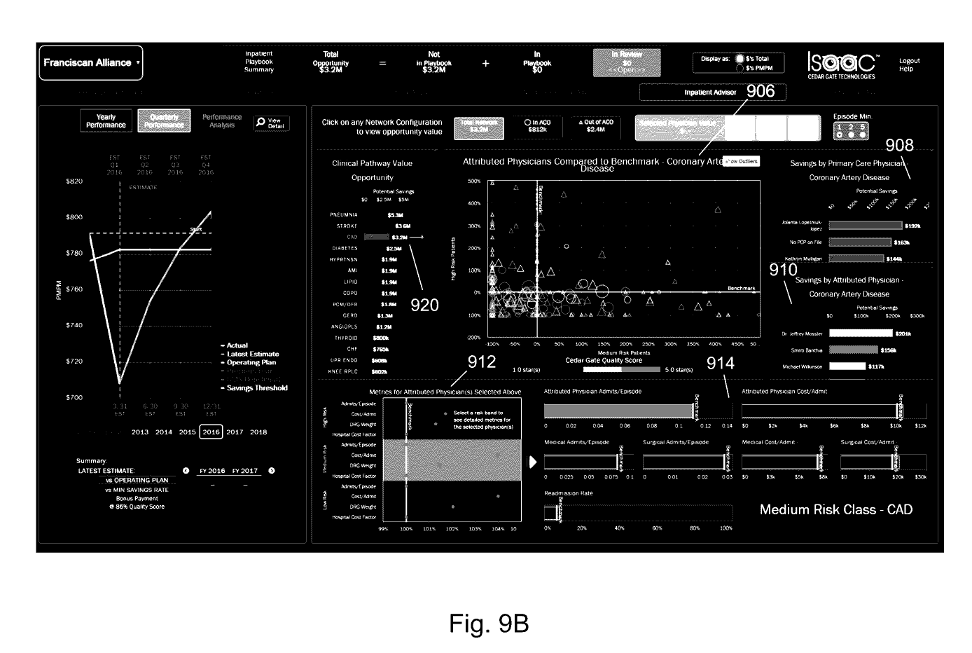

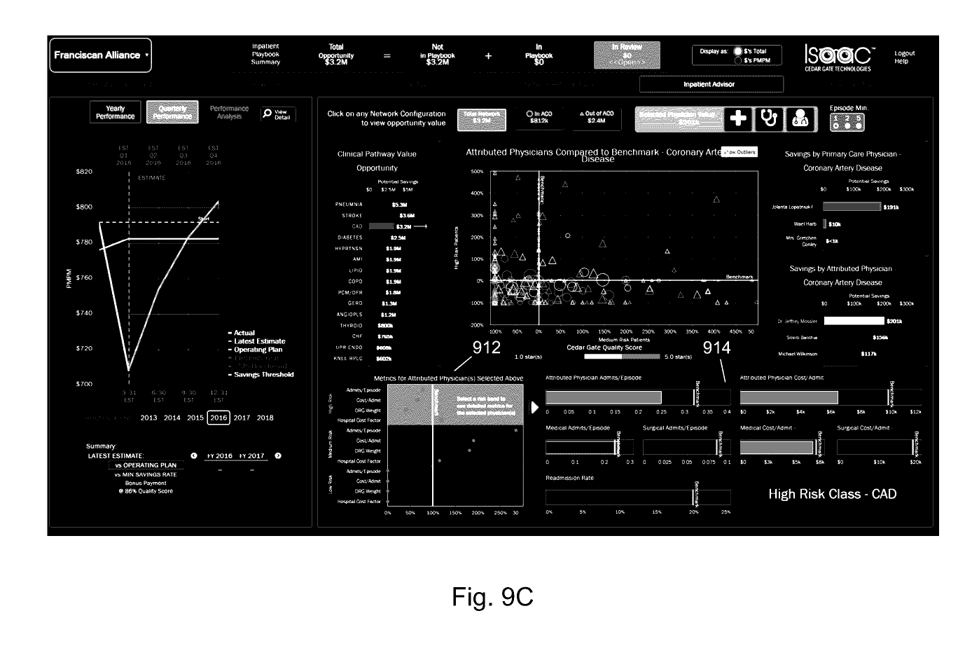

FIG. 9A-9D present an exemplary inpatient advisor interface according to an embodiment of the present invention. Inpatient advisor logic is operable to analyze the relationships between primary care physicians and attributed physicians for treating specific patients which required an inpatient admission. An inpatient advisor logic may identify attributed physicians whose episode costs seem to indicate an over-utilization of inpatient services. The inpatient advisor logic may generate detailed metrics for identifying potential drivers to over-utilization in the inpatient advisor interface. Additionally, the inpatient advisor logic can generate charts and metrics that stratify physician performance by the risk class (e.g., severity of illness burden) of the patients they treated.

Inpatient performance 902 presents actual performance and future projections including an operating plan and latest estimate plotted against a savings threshold for a defined time period (e.g., quarterly, yearly). Inpatient playbook summary 918 may indicate dollar values of total opportunities, opportunities not in playbook, opportunities in playbook, and opportunities in review. Clinical pathway value opportunity 904 is operable to summarize and order available savings opportunity, defined by inpatient advisor calculation metrics, for each clinical pathway in order of greatest to least value.

Attributed physicians compared to benchmark 906 may present a bubble chart that can be used to identify attributed physicians with high inpatient cost per episode, relative to their inpatient benchmark. Separate inpatient benchmarks may be created for different risk profiles and physicians can be plotted based on their utilization patterns relative to the benchmarks. A selection of a plot in attributed physicians compared to benchmark 906 updates charts of savings by attributed physician 910 and savings by primary care physician 908. Savings by attributed physician 910 is able to summarize the attributed physician's overall savings opportunity based on selected filters, and plots them in descending order. This graph is affected by clinical pathway (clinical pathway value opportunity 904) and savings by primary care physician 908 filters, and adjusts to show the scope of savings within the current selection. Users can select a single clinical pathway at a time from clinical pathway value opportunity 904 to narrow the scope of their analysis. FIG. 9B presents a selection of a clinical pathway 920. Attributed physicians compared to benchmark 906, savings by primary care physician 908, and savings by attributed physician 910 are updated to reflect the selection of clinical pathway 920.

Metrics for attributed physician 912 may reflect one or more physicians selected from savings by attributed physician 910. The metrics for attributed physician 912 breaks out a physician's inpatient performance against four benchmarks: admits per episode, cost per admit, DRG weight, and hospital cost factor. Performance can be split into three categories of beneficiary: high, medium, and low risk. These models may be used to identify the drivers of a physician's inpatient cost per episode. For more details on a specific risk band, the plotted area in metrics for attributed physician 912 may be selected to activate that risk class for metrics for selected risk class 914.

Metrics for selected risk class 914 provides detailed metrics for a single risk class at a time. A different risk band may be selected from the metrics for attributed physician 912 to change the focus of the detailed metrics. FIG. 9C presents a selection of the high risk beneficiary class for the selected physician(s). The bars may be colored red if the selected physician(s) perform worse than the benchmark, green if they perform better, and yellow if they match the benchmark exactly. The metrics for selected risk class 914 can further categorize the admits per episode and cost per admit into surgical admit and medical admission components. This section may also show the physician's readmission rate for beneficiaries in a selected clinical pathway.

A physician can be analyzed by the inpatient advisor logic based on how they manage patients with different risk profiles. Particularly, the inpatient advisor logic looks at episodes which required an inpatient admission and compares the episodes to inpatient benchmarks. Inpatient benchmarks may be created by comparing spend, admissions, and utilization for all physicians who have treated patients with similar diagnoses and comorbidities. Physicians with extra costs in these areas can be identified as higher savings opportunities. Plays may be recommended for adding to a playbook campaign to, for example, reduce readmission by finding attributed physicians with high savings and high admissions or episodes to rehabilitate, and storing attributed physicians who are routinely above both benchmarks for a clinical pathway and evaluate their facility usage and inpatient trends. Physicians may be selected to a playbook by using physician value navigation bar 916.

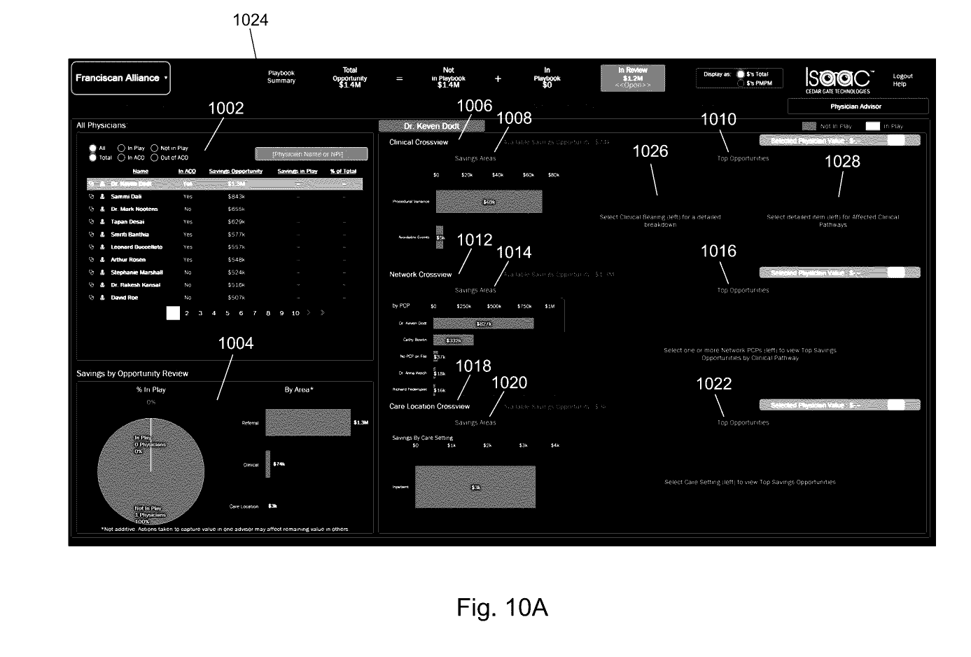

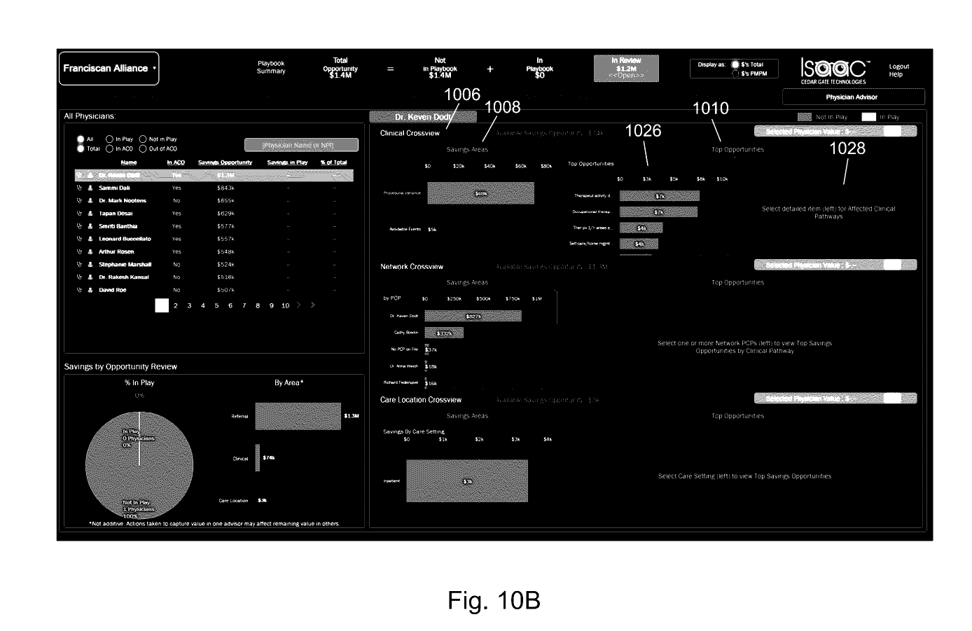

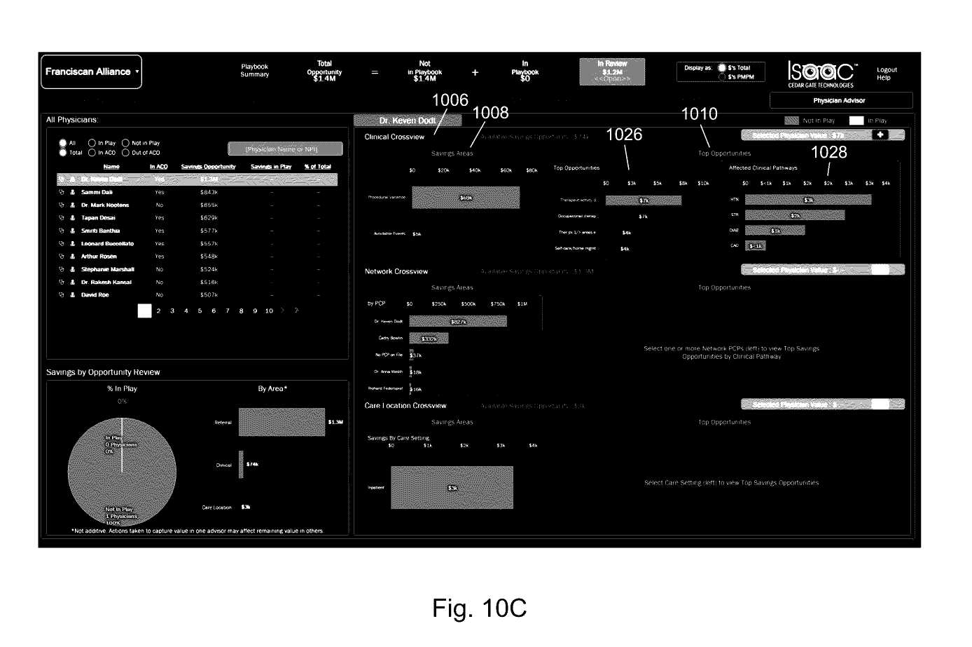

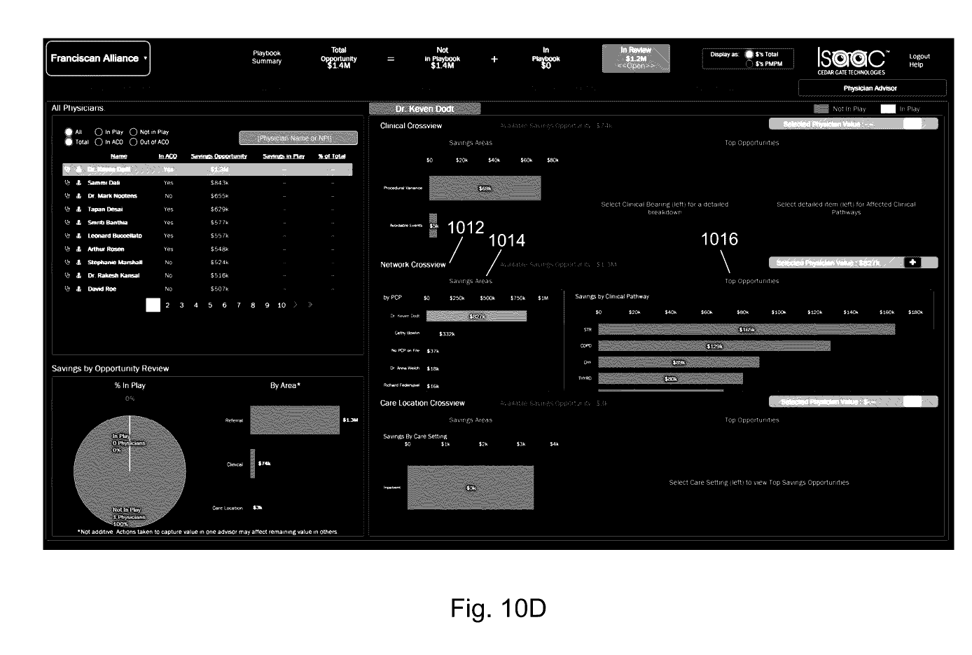

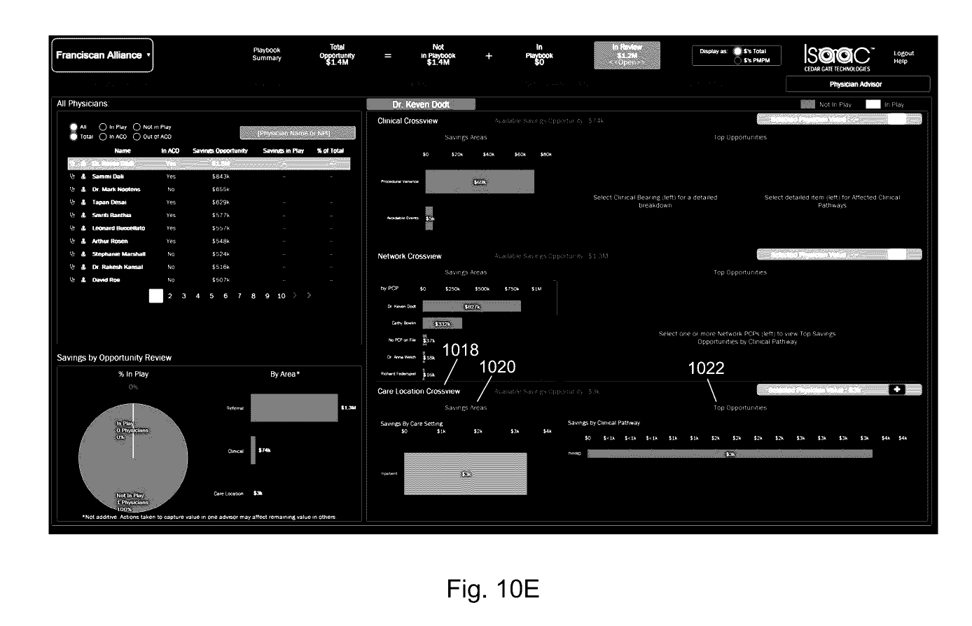

FIG. 10A-10E presents an exemplary physician advisor interface according to an embodiment of the present invention. Physician advisor logic is operable to provide an entire scope of prescriptive opportunities, for each attributed physician, from all clinical pathways and the other advisor logics, and summarize the playbook campaign engagement of the physician. The physician advisor interface may present a summary of other advisors for avoidable complications, procedure, network referrals, and inpatient performance. This allows a user to evaluate the same opportunities presented in clinical advisor, inpatient advisor, and network referral advisor without the context of other physicians. Plays may be recommended for adding to a playbook campaign based on the physician advisor logic similar to other advisor logics but focusing on individual physicians. Physician advisor logic is operable to aggregate savings from clinical advisor logic, network referral advisor logic, and inpatient advisor logic.

Physician playbook summary 1024 may indicate dollar values of total opportunities, opportunities not in playbook, opportunities in playbook, and opportunities in review. Savings by opportunity review 1004 provide, at a glance, how actively the organization is pursuing a physician's savings opportunity. The savings by opportunity review 1004 may include a “% In Play” pie chart that shows a percentage of the physician's savings opportunity which has been added to active, “In Play” playbook campaigns. The three bar charts show the dollar value, per advisor, of active playbook campaigns “By Area.”

Physician list 1002 may be used to browse physicians and to get a quick view of their savings opportunity and engagement. The columns in the list may be sortable by name, in ACO, savings opportunity, savings in play, and % of total. The list may also be filtered by playbook engagement or network status, or by searching a specific physician name or NPI. Selections from this list cascade to the crossviews (clinical crossview 1006, network crossview 1012, and care location crossview 1018) on the page. The crossviews are configurable to aggregate a physician's savings opportunity from various advisors (e.g., clinical, network referral, and facility advisors). Savings opportunities from each crossview may be added directly to a playbook from the crossviews. “Available Savings Opportunity” values may be displayed for each of the crossviews that show the sum of opportunities not yet in a playbook campaign for specific physician(s), in that advisor.

Clinical crossview 1006 includes savings areas 1008 and top opportunities 1010. Saving areas 1008 may be configured to display savings areas by clinical pathway opportunity type. An opportunity list in top opportunities 1010 can be used to evaluate the potential savings for each opportunity type in either a selected clinical pathway, or the overall total potential savings for that physician for that type. By reviewing the savings by clinical pathway, one can evaluate the savings opportunity for that physician in each pathway. FIG. 10B presents a feature for allowing a user may select a given clinical pathway opportunity type in savings areas 1008 to reveal “top opportunities” details in clinical bearing details 1026. The opportunity details in clinical bearing details 1026 may be selected to show affected clinical pathways 1028, as illustrated in FIG. 10C.

Network crossview 1012 includes savings areas 1014 and top opportunities 1016. Savings areas 1014 may be configured to display savings areas by PCP. FIG. 10D presents a feature for allowing a user to select a PCP from savings areas 1012 to reveal savings by clinical pathway under top opportunities 1016.

Care location crossview 1018 includes savings areas 1020 and top opportunities 1022. Savings areas 1018 may be configured to display savings areas by care setting. The role that the facility or other providers may have played in cost and quality metrics may also be analyzed. In particular, provider metrics of the physician can be compared with peers according to care setting, inpatient relative performance, occurrence rate, and facility occurrence rate. Care setting data may be presented to show the utilization of major care settings (e.g., inpatient, acute, ancillary, community, and post-acute) for the clinical pathway by a physician.

FIG. 10E presents a feature for allowing a user to select a care setting to reveal savings by clinical pathway under top opportunities 1022. Peer rates may indicate how other physicians utilize these care settings during episodes, compared to the physician's utilization. Inpatient relative performance may also be provided to indicate inpatient advisor metrics for attributed physician chart from the inpatient advisor logic. The physician's utilization may be compared to all other physicians in the same clinical pathway and risk class, to determine whether the physician is experiencing better or worse outcomes compared to peers. The occurrence of avoidable clinical events in facilities may also be monitored to help identify whether the occurrence is a physician issue or a facility issue. Facility costs may be detailed to show the total spend for aggregated episodes in any facilities utilized by the physician in the selected care setting, and provider costs can be detailed to show the total spend of other providers in a care coordination team during episodes of care in the selected care setting.

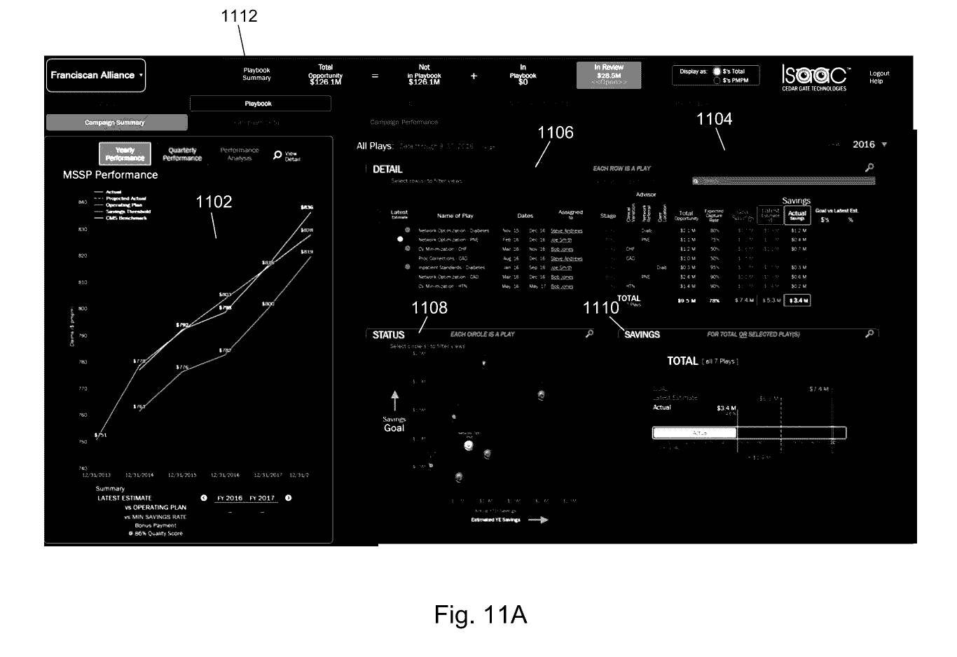

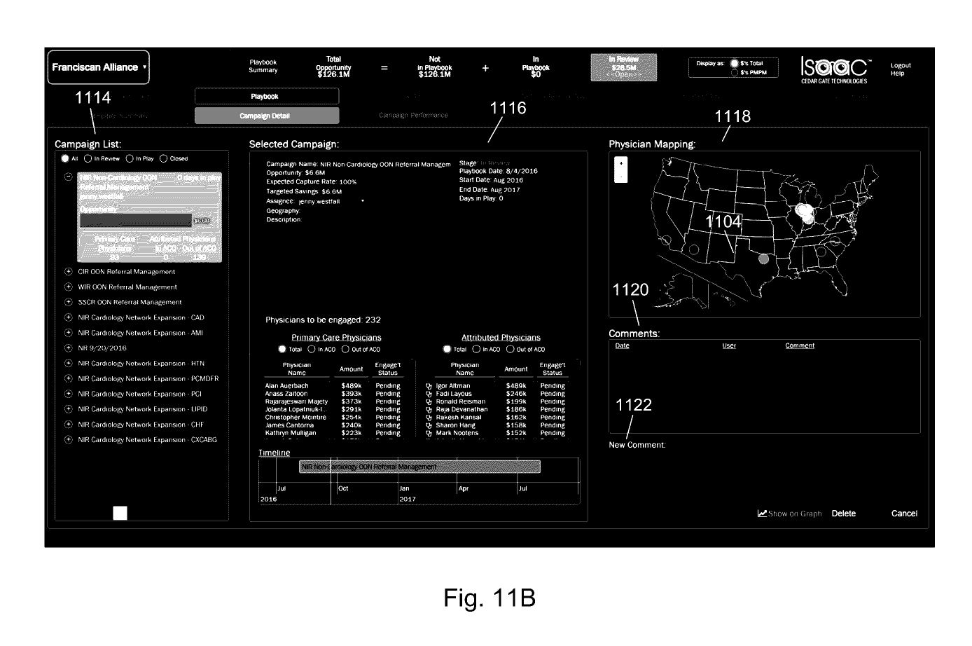

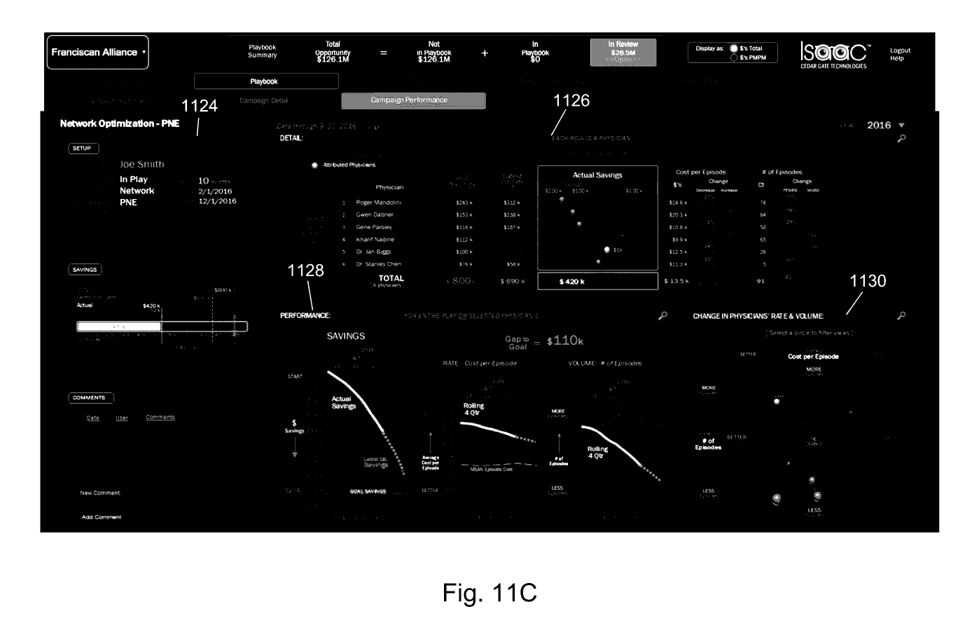

FIG. 11A presents a playbook campaign summary that allows users to see playbook campaigns that an organization has created. A playbook may be used to encourage accountability for pursuing savings opportunity and developing a financial operating plan to meet organizational goals. According to one embodiment, a playbook is a collection of saving opportunities that an organization has decided to operationally pursue in order to realize the opportunity presented in the various advisors. Playbook summary 1112 may indicate dollar values of total opportunities, opportunities not in playbook, opportunities in playbook, and opportunities in review. When members of the organization wish to realize the value of a particular savings opportunity surfaced in one of the advisors, they may add a play to the playbook.

The Playbook facilitates work assignment and accountability, modeling the financial impact of the savings opportunity realization on the underlying contract, and building an operating plan that the organization can manage to with each new data refresh. MSSP performance 1102 presents actual performance and future projections including an operating plan and projected performance against a savings threshold and a CMS (Centers for Medicare and Medicaid Services) benchmark for a defined time period (e.g., quarterly, yearly). By adding campaigns to a playbook, the graph is able to visually model the impact of campaigns against the overall performance of the ACO or other value based reimbursement program. Each advisor surfaces savings opportunities within each clinical pathway that can be added to playbook. By selecting an opportunity on an advisor and adding some or all of it to playbook, the user can observe the financial impact of executing on the stated value of the savings opportunity. A play can be as narrow as counseling a single physician within a single clinical pathway about an avoidable clinical event, to as broad as advising 20+ primary care physicians to alter their referral patterns across multiple clinical pathways. Each campaign has a defined savings amount associated with it. While the default is 100%, the user can elect to enter an expected capture rate percentage of less than 100% if they so choose, which adjusts the expected savings from that play down to the corresponding amount.

The characteristics of each play can be seen in “all plays” window 1104. Window 1104 includes campaign detail 1106, status 1108, and savings 1110. Each row in campaign detail 1106 is representative of a play. Details for each play in the list may include latest estimate status, name of play, dates of play, person play is assigned to, stage, advisor added from, total opportunity cost, capture rate, and savings (goal savings, latest estimate, actual savings, and goal vs. latest estimate). A search bar in the top right corner of campaign detail 1106 may be used by a user to filter assignee or clinical pathway, stage, start and duration of relevant campaigns. Status 1108 presents a chart including a plotting of plays from the list in campaign detail 1106 based on savings goal vs. actual year-to-date savings. Savings 1110 may present actual, latest estimate, and goal for year-end savings for total or selected plays.

FIG. 11B presents a playbook campaign detail interface that can be used to further analyze and coordinate the pursuit of savings opportunities in a given campaign. A campaign may be selected from a campaign list 1114 to update selected campaign details 1116. Selected campaign details 1116 may include a summary card that shows quick details about the campaign. The details may include expected capture rate (0-100%), assignee, start and end dates of the campaign, geography, and action description. The selected campaign details 1116 may also include a number of “physicians to be engaged” that may be analyzed to determine the value of physician relationships. A list of the physicians to be engaged may be filtered by in or out of ACO, and selected to see the breakdown of his or her savings opportunity.

A “timeline” feature may be presented within selected campaign details 1116 to specify when a play will be executed on by their organization. A user can adjust the position and length of a timeline bar as long as the campaign is still “in review.” By clicking on the orange bar on the timeline, that play's timeline is selected. This permits the user to move the timeline into the future, and/or shorten or elongate the default amount of time to execute the play. By clicking and dragging the middle of the bar, a user can drag the timeline into the future. Clicking on the left or right boundary edge allows the user to shorten or lengthen the duration of the play execution. The granularity of the timeline ticks may be adjusted to select durations for plays.

Physician mapping 1118 may show the geographic relationship between physicians. This may help explain referral patterns, or, just as likely, may prove that physician geography does not impact the relationships. Progress on the campaign may also be indicated via comments 1120. New comments (1122) may also be added to record actions taken in pursuit of the savings.

FIG. 11C presents a playbook campaign performance interface. Play summary 1124 may provide setup data including assignee, stage, advisor, clinical pathway, description, duration, start and end dates. The play summary 1124 also includes savings details that present actual, latest estimate, and goal for year-end savings for total or selected plays. Comments may also be provided along with any new comments that may be added. Detail 1126 includes savings details by individual physicians. Each physician may be presented with goal savings, latest estimate, actual savings, cost per episode, and number of episodes. Performance 1128 includes performance charts of savings, rate (cost per episode), and volume (number of episodes). Change in physician's rate & volume 1130 presents a plot of physicians of change in number of episodes vs. change in cost per episode.

FIG. 12 illustrates an exemplary network leakage interface according to an embodiment of the present invention. The illustrated interface may present information for identifying sources of network leakage (e.g., when primary care physicians refer patients to out-of-system providers, rather than to those in their network, resulting in significant business losses). Network leakage information may be useful in identifying patient behavior in and outside of health care systems' networks across services and procedures, physicians and practices, and geographies.

Inpatient leakage by MDC 1202

Inpatient facility location 1204

Inpatient leakage by referral source 1206

Inpatient leakage by state 1208

Inpatient facility type 1210

Inpatient facility spend 1212

Inpatient leakage by primary care provider 1214

FIGS. 1 through 12 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A system for facilitating improved monitoring and managing healthcare performance, the system comprising:
one or more network interfaces configured to provide access to a network and to enable communication with one or more healthcare manager devices; and
one or more data processing servers coupled to the one or more network interfaces, the one or more data processing servers configured to execute instructions for:
receiving healthcare data from a plurality of data source devices over the network;
extracting medical data from the received healthcare data regarding a plurality of patient procedures performed by a plurality of healthcare providers;
grouping the extracted medical data according to one or more predefined patterns;
executing an analytic engine for analyzing the grouped medical data to determine statistical variations in cost or quality of the patient procedures performed by the healthcare providers and to identify one or more of the healthcare providers responsible for statistically significant variations;
executing a plurality of opportunity advisor modules to generate prescriptive opportunities for reducing the determined statistical variations associated with the identified one or more healthcare providers;
storing the prescriptive opportunities as plays in a playbook module; and
generating output of the analytics engine and playbook module to transmit to the one or more healthcare manager devices.

2. The system of claim 1 wherein receiving healthcare data comprises receiving one or more of the following: group health service transaction data, patient medical data, provider data, health plan data, provider contract data, lab data, pharmacy data, market trend data, reference data, payment data, patient demographic and enrollment data, benefit plan data, and claim reimbursement data.

3. The system of claim 1, wherein grouping comprises grouping the extracted medical data according to episodes of care based on clinically related activities in the extracted medical data.

4. The system of claim 3, wherein grouping further comprises grouping the episodes of care into clinical pathways.

5. The system of claim 4, wherein executing the analytical engine comprises arranging episodes within each clinical pathway by patient risk stratifications to generate healthcare provider clinical pathway benchmark data and analyzing the healthcare provider clinical pathway benchmark data to derive an expected value for each clinical pathway.

6. The system of claim 5, wherein executing the analytical engine comprises:
collecting groups of episodes of care based on common clinical characteristics;
creating a multivariate regression model for each group of episodes of care using as predictive variables patient age, gender, co-morbidities, and severity of illness for a specific clinical condition and using as a response variable a cost of the episode of care; and
calculating expected savings as a difference between the episode cost and predicted costs.

7. The system of claim 6, wherein executing the analytical engine further comprises:
generating a credibility interval for outputs of the multivariate regression model; and
capping an upside and downside of the calculated expected savings to the credibility interval.

8. The system of claim 6, wherein collecting groups of episodes of care comprises removing any services not clearly related to a condition from each episode of care.

9. The system of claim 3, wherein executing the analytics engine comprises determining statistical variations in cost or quality of the episodes of care.

10. The system of claim 9 wherein at least one of the opportunity advisor modules generates prescriptive opportunities for reducing unnecessary costs or recovering lost revenue by the identified one or more healthcare providers during episodes of care.

11. The system of claim 9 wherein at least one of the opportunity advisor modules generates prescriptive opportunities for improving clinical procedures by the identified one or more healthcare providers during episodes of care.

12. The system of claim 9 wherein at least one of the opportunity advisor modules generates prescriptive opportunities for improving operational efficiencies during episodes of care.

13. The system of claim 9, wherein at least one of the opportunity advisor modules is a financial contract advisor module which reports and forecasts performance of a financial contract involving a healthcare payer based on identified cost savings opportunities represented by one or more plays in the playbook module.

14. The system of claim 13, wherein the financial contract advisor module reports on a contract's performance by generating an annual operating plan from plays stored in the playbook and benchmarks for the contract, and wherein the financial contract advisor module performs financial contract forecasting by identifying a set of selected opportunities, reflecting each selected opportunity's expected contribution, adjusting such contributions over time to reflect actual versus planned completion of the selected opportunities, and predicting a final level of success for such selected opportunities as compared to stored forecast medical costs for services represented in the plays.

15. The system of claim 3 wherein the analytics engine analyzes relationships between primary care providers and attributed providers during episodes of care.

16. The system of claim 1 wherein at least one of the opportunity advisor modules generates prescriptive opportunities for a given healthcare provider and generate a set of plays for the given healthcare provider in the playbook.

17. The system of claim 1, wherein at least one of the opportunity advisor modules comprises a network leakage module that identifies patient behavior in and outside of a healthcare system's network and generates prescriptive opportunities to decrease an amount of healthcare services provided outside of the network.

18. The system of claim 17, wherein the network leakage module:
gathers a collection of trigger events from processed claims on healthcare services;
performs a time series analysis of the processed claims to determine provider referring events;
aggregates services provided during the triggering events and classifies the aggregated services based on network relationships of the provider delivering them; and
generates data representing a ratio of the classified services to a total amount of all services.

19. The system of claim 1 wherein the generated output comprises a graphical user interface that is accessible via a web-based feature, a software application, or a cloud computing service.

20. A system for monitoring and managing healthcare performance, the system comprising:
a data aggregator that collects healthcare data from one or more data source systems and groups the healthcare data into sets based on episodes of care;
an analytic engine module configured to analyze the aggregated and grouped healthcare data to determine statistical variations in cost or quality of the patient procedures performed by the healthcare providers and to identify one or more of the healthcare providers responsible for statistically significant variations in the grouped episodes of care;
a plurality of opportunity advisor modules configured to generate prescriptive opportunities for reducing the determined statistical variations associated with the identified one or more healthcare providers;
a performance monitoring component configured to generate performance data based on the healthcare data, and generate graphical user interface data based on the performance data, the analysis of the healthcare data, execution of the at least one advisor logic, and a playbook, the graphical user interface accessible via a network and enables user access to the performance data, the at least one advisor logic, and the playbook; and
a playbook module configured to generate scripts associated with the created opportunities, create the playbook, and add a selection of the scripts to the playbook.

21. The system of claim 20 wherein the healthcare data includes health service transactions, patient medical data, provider data, health plan data, provider contract data, lab data, pharmacy data, market trend data, reference data, payment data, patient demographic and enrollment data, benefit plan data, and reimbursement data.

22. The system of claim 20 wherein the graphical user interface is accessible via a web-based feature, a software application, or a cloud computing service.

23. The system of claim 20 wherein the opportunity advisor modules include a clinical advisor module, a network referral advisor module, an inpatient advisor module, and a provider advisor module.

24. The system of claim 20 wherein the analytic engine module is further configured to analyze clinically related activities during episodes of care and evaluate unnecessary costs.

25. The system of claim 20 wherein the analytic engine module is further configured to analyze relationships between primary care providers and attributed providers.

26. The system of claim 20 wherein the analytic engine module is further configured to:
identify an overall scope of prescriptive opportunities, for a given provider, from a plurality of clinical pathways and a plurality of advisor logics; and
summarize a playbook campaign engagement of the given provider.

27. The system of claim 20 wherein the performance monitoring component is further configured to monitor performance of the created opportunities associated with the selection of scripts added to the playbook.

28. The system of claim 20 wherein the performance data includes contract financial performance, clinical performance, and operational performance.

29. The system of claim 28 wherein at least one of the opportunity advisor modules comprises a financial contract advisor module which reports and forecasts performance of a financial contract involving a healthcare payer based on identified cost savings opportunities and forecast medical cost trend data.

30. The system of claim 20 wherein the analytics models engine is further configured to compare performance data, generate cost distributions, and determine an optimal intersection between cost and quality of care.

31. The system of claim 20 wherein at least one of the opportunity advisor modules comprises a network leakage module that identifies patient behavior in and outside of a healthcare system's network, aggregates and classifies services based on network relationships of the provider delivering them, generates data representing a ratio of the classified services to a total amount of all services, and generates prescriptive opportunities to decrease an amount of healthcare services provided outside of the network.

32. A method for monitoring and managing healthcare performance, the method performed by a server connected to a network and in communication over the network with a plurality of data source devices providing healthcare data and one or more healthcare manager devices, the method comprising:
receiving healthcare data from the data source devices over the network;
extracting medical data from the received healthcare data regarding a plurality of patient procedures performed by a plurality of healthcare providers;
grouping the extracted medical data according to episodes of care based on clinically related activities in the extracted medical data and grouping the episodes of care into clinical pathways;
executing an analytic engine for analyzing the grouped medical data to determine statistical variations in cost or quality of the patient procedures performed by the healthcare providers and to identify one or more of the healthcare providers responsible for statistically significant variations;
executing a plurality of opportunity advisor modules to generate prescriptive opportunities for reducing the determined statistical variations associated with the identified one or more healthcare providers; and
transmitting output of the analytics engine to the one or more healthcare manager devices.

33. The method of claim 32, wherein executing the analytical engine comprises arranging episodes within each clinical pathway by patient risk stratifications to generate healthcare provider clinical pathway benchmark data and analyzing the healthcare provider clinical pathway benchmark data to derive an expected value for each clinical pathway.

34. The method of claim 33, wherein executing the analytical engine comprises:
collecting groups of episodes of care based on common clinical characteristics;
creating a multivariate regression model for each group of episodes of care using as predictive variables patient age, gender, co-morbidities, and severity of illness for a specific clinical condition and using as a response variable a cost of the episode of care; and
calculating expected savings as a difference between the episode cost and predicted costs.

35. The method of claim 34, wherein executing the analytical engine further comprises:
generating a credibility interval for outputs of the multivariate regression model; and
capping an upside and downside of the calculated expected savings to the credibility interval.

36. The method of claim 34, wherein collecting groups of episodes of care comprises removing any services not clearly related to a condition from each episode of care

37. The method of claim 32 comprising executing at least one of the opportunity advisor modules to generate prescriptive opportunities for reducing unnecessary costs or recovering lost revenue by the identified one or more healthcare providers during episodes of care.

38. The method of claim 32 comprising executing at least one of the opportunity advisor modules to generate prescriptive opportunities for improving clinical procedures by the identified one or more healthcare providers during episodes of care.

39. The method of claim 32 comprising executing at least one of the opportunity advisor modules to generate prescriptive opportunities for improving operational efficiencies during episodes of care.

40. The method of claim 32 comprising executing a financial contract opportunity advisor module to report and forecast performance of a financial contract involving a healthcare payer based on identified cost savings opportunities.

41. The method of claim 40, wherein executing the financial contract opportunity advisor module comprises reporting on a contract's performance by generating an annual operating plan using plays stored in the playbook and benchmarks for the contract, identifying a set of selected opportunities, reflecting each selected opportunity's expected contribution, adjusting such contributions over time to reflect actual versus planned completion of the selected opportunities, and predicting a final level of success for such selected opportunities as compared to stored forecast medical costs for services represented in the plays.

42. The method of claim 32, comprising executing a network leakage opportunity module to identify patient behavior in and outside of a healthcare system's network and generate prescriptive opportunities to decrease an amount of healthcare services provided outside of the network.

43. The method of claim 42, wherein executing the network leakage module comprises:
gathering a collection of trigger events from processed claims on healthcare services;
performs a time series analysis of the processed claims to determine provider referring events;
aggregates services provided during the triggering events and classifies the aggregated services based on network relationships of the provider delivering them; and
generates data representing a ratio of the classified services to a total amount of all services.

44. The method of claim 32 wherein the analytics engine analyzes relationships between primary care providers and attributed providers during episodes of care.

45. The method of claim 32 comprising generating a set of plays for the healthcare providers and storing the plays in a playbook.
